(19) United States
(12) Patent Application Publication
(10) Pub. No.: US 2025/0356848 A1
(43) Pub. Date: Nov. 20, 2025

(54) SYSTEMS AND METHODS FOR EMOTION-BASED CALL SUMMARIZATION

(71) Applicant: Optum, Inc., Minnetonka, MN (US)

(72) Inventors: Manish CHOPRA, Haryana (IN); Sumeet Shivshankar SHAHU, Maharashtra (IN); Daksh PEEPAT, Delhi (IN); Chandni NANDA, Delhi (IN); Gourav AWASTHI, Haryana (IN); Chirag MITTAL, Haryana (IN)

(21) Appl. No.: 18/668,748

(22) Filed: May 20, 2024

(51) Int. Cl. G10L 15/18; G10L 15/04; G10L 15/26

(52) U.S. Cl. CPC G10L 15/1815; G10L 15/04; G10L 15/26

(57) ABSTRACT

Embodiments of the present disclosure provide systems and methods for emotion-based call summarization. One method may include receiving an emotion prediction vector for an utterance text segment from a transcript data object, the emotion prediction vector comprising a plurality of emotion prediction scores respectively corresponding to a plurality of emotion identifiers; generating a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category; identifying the utterance text segment as a relevant utterance from the transcript data object based on a comparison between the domain-specific relevancy prediction and a relevancy threshold; and initiating a performance of a machine learning summarization operation based on the utterance text segment.

### BACKGROUND

Various embodiments of the present disclosure address technical challenges related to computer text comprehension and, more particularly, machine learning techniques, such as sentiment analysis and text summarization that enable computer text comprehension. Traditionally, machine learning has been applied independently to (i) identify an underlying sentiment, through sentiment analysis, of text and, separately, (ii) to summarize, through summarization techniques, important aspects from the same text. Thus, to understand both the underlying sentiment and the important aspects from text, a computer is traditionally required to operate two independent processing pipelines, which is impractical for computers with access to limited computing resources.

Conventional machine learning summarization techniques, alone, require significant processing resources that increase with the size of text input for summarization. For example, deep learning approaches that are trained to generate extractive and/or abstractive text summaries may require complex considerations between words and phrases within a corpus of text that is exponentially more complex as the size of the text corpus increases. Even in cases with unconstrained computing resources, the accuracy and quality of traditional machine learning summarization techniques is directly proportional to the amount of available labelled training datasets. This mandates large, labelled training datasets for training a model that are unavailable for most applications. Even if there is an availability of sufficient labelled training data, it is difficult to train model to capture all the important aspects of the text required for summary.

Various embodiments of the present disclosure make important contributions to various existing machine learning approaches by addressing these technical challenges.

### BRIEF SUMMARY

Various embodiments of the present disclosure provide systems and methods for improving machine learning and, more specifically, improving machine learning text comprehension. Some techniques of the present disclosure provide a machine learning pipeline that leverages sentiment analysis techniques, such as deep learning emotion models, to filter and rank text utterances from text before a machine learning summarization process. By doing so, the size of large text corpuses may be reduced to enable accurate identification of relevant utterances for an extractive summary. This extractive summary may be used as a basis for a text summarization process to generate more nuanced and comprehensive summaries that capture both content and underlying emotional nuances leading to more contextually rich and meaningful summaries at a fraction of the computation cost traditionally required. As described herein, actionable insights from text summaries, generated in accordance with the techniques of the present disclosure, may enhance computer comprehension leading to improved decision making.

In some embodiments, a computer-implemented method includes receiving, by one or more processors and from an emotion classification model, an emotion prediction vector for an utterance text segment from a transcript data object, the emotion prediction vector comprising a plurality of emotion prediction scores respectively corresponding to a plurality of emotion identifiers; generating, by the one or more processors, a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category; identifying, by the one or more processors, the utterance text segment as a relevant utterance from the transcript data object based on a comparison between the domain-specific relevancy prediction and a relevancy threshold; and initiating, by the one or more processors, a performance of a machine learning summarization operation based on the utterance text segment.

In some embodiments, a computing system includes memory and one or more processors communicatively coupled to the memory, the one or more processors are configured to receive, from an emotion classification model, an emotion prediction vector for an utterance text segment from a transcript data object, the emotion prediction vector comprising a plurality of emotion prediction scores respectively corresponding to a plurality of emotion identifiers; generate a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category; identify the utterance text segment as a relevant utterance from the transcript data object based on a comparison between the domain-specific relevancy prediction and a relevancy threshold; and initiate a performance of a machine learning summarization operation based on the utterance text segment.

In some embodiments, one or more non-transitory computer-readable storage media include instructions that, when executed by one or more processors, cause the one or more processors to receive, from an emotion classification model, an emotion prediction vector for an utterance text segment from a transcript data object, the emotion prediction vector comprising a plurality of emotion prediction scores respectively corresponding to a plurality of emotion identifiers; generate a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category; identify the utterance text segment as a relevant utterance from the transcript data object based on a comparison between the domain-specific relevancy prediction and a relevancy threshold; and initiate a performance of a machine learning summarization operation based on the utterance text segment.

### BRIEF DESCRIPTION OF THE DRAWINGS

FIG. 1 provides an example overview of an architecture in accordance with some embodiments of the present disclosure.

FIG. 2 provides an example computing entity in accordance with some embodiments of the present disclosure.

FIG. 3 provides an example client computing entity in accordance with some embodiments of the present disclosure.

FIG. 4 is a dataflow diagram showing example data structures and modules for implementing a multi-stage, sentiment-based text interpretation process in accordance with some embodiments discussed herein.

FIG. 5 is a dataflow diagram showing example data structures and modules for adapting sentiment analysis for text summarization in accordance with some embodiments discussed herein.

FIG. 6 is an operational example of a transcript data object in accordance with some embodiments discussed herein.

FIG. 7 is an operational example of a preprocessing stage of the multi-stage, sentiment-based text interpretation process in accordance with some embodiments discussed herein.

FIG. 8 is an operational example of an emotion ontology in accordance with some embodiments discussed herein.

FIG. 9 is an operational example of a sentiment analysis stage of the multi-stage, sentiment-based text interpretation process in accordance with some embodiments discussed herein.

FIG. 10 is an operational example of a sentiment analysis adapting stage of the multi-stage, sentiment-based text interpretation process in accordance with some embodiments discussed herein.

FIG. 11 is an operational example of sets of category-specific emotion identifiers in accordance with some embodiments discussed herein.

FIG. 12 is an operational example of a domain-specific relevancy prediction stage of the multi-stage, sentiment-based text interpretation process in accordance with some embodiments discussed herein.

FIG. 13 is an operational example of relevant utterances from a transcript data object in accordance with some embodiments discussed herein.

FIG. 14 is an operational example of irrelevant utterances in accordance with some embodiments discussed herein.

FIG. 15 is an operational example of transcript summaries in accordance with some embodiments discussed herein.

FIG. 16 is an operational example of a sentiment assignment stage of the multi-stage, sentiment-based text interpretation process in accordance with some embodiments discussed herein.

FIG. 17 is a flowchart diagram of an example multi-stage, sentiment-based text interpretation process in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

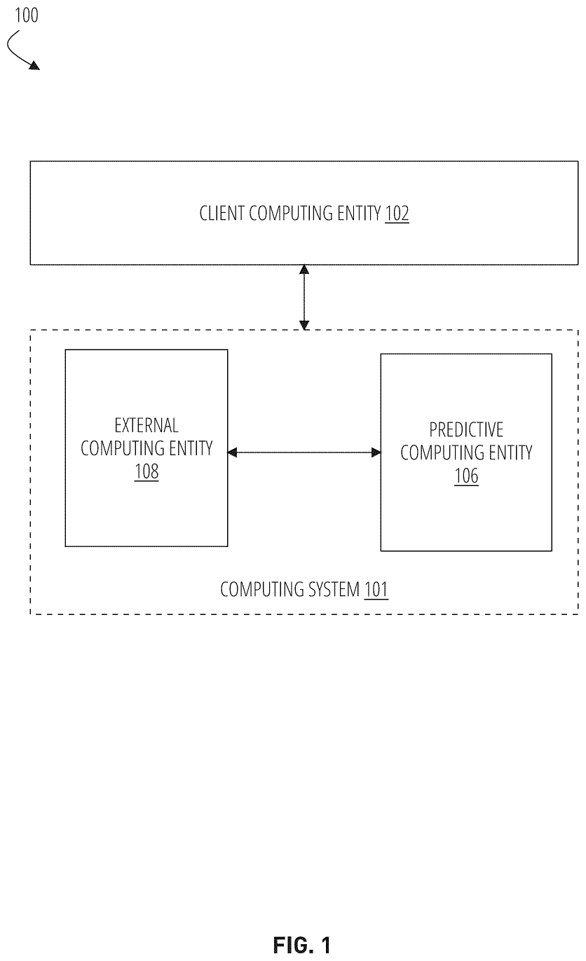

FIG. 1 provides an example overview of an architecture 100 in accordance with some embodiments of the present disclosure. The architecture 100 includes a computing system 101 configured to receive request, such as generative text requests, from client computing entities 102, process the requests to generate generative text outputs, and provide the generated text outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be integrated to form a machine learning pipeline for improved text comprehension and computing resource usage. The machine learning pipeline may be configured to leverage sentiment analysis to reduce computing resources required for traditional text summarization processes. This technique will lead to more accurate, reliable, and comprehensive insights from text at a fraction of the computational cost.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate outputs, such as predictive outputs, transcript summaries, transcript sentiments, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., generative text techniques, classification techniques, sentiment analysis techniques, and/or the like) described herein. The external computing entities 108, for example, may include and/or be associated with one or more entities that may be configured to receive, transmit, store, manage, and/or facilitate datasets, such as the training data store, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

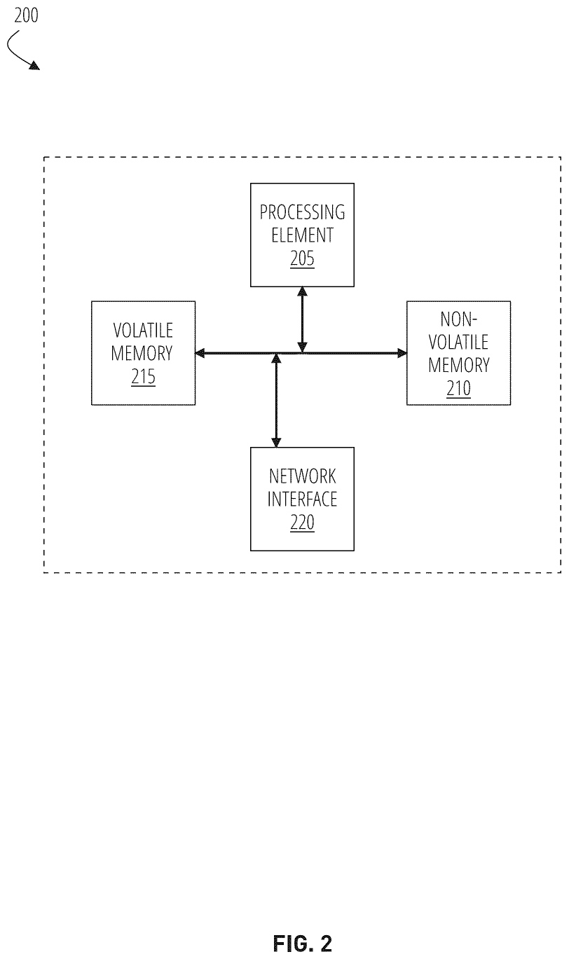

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

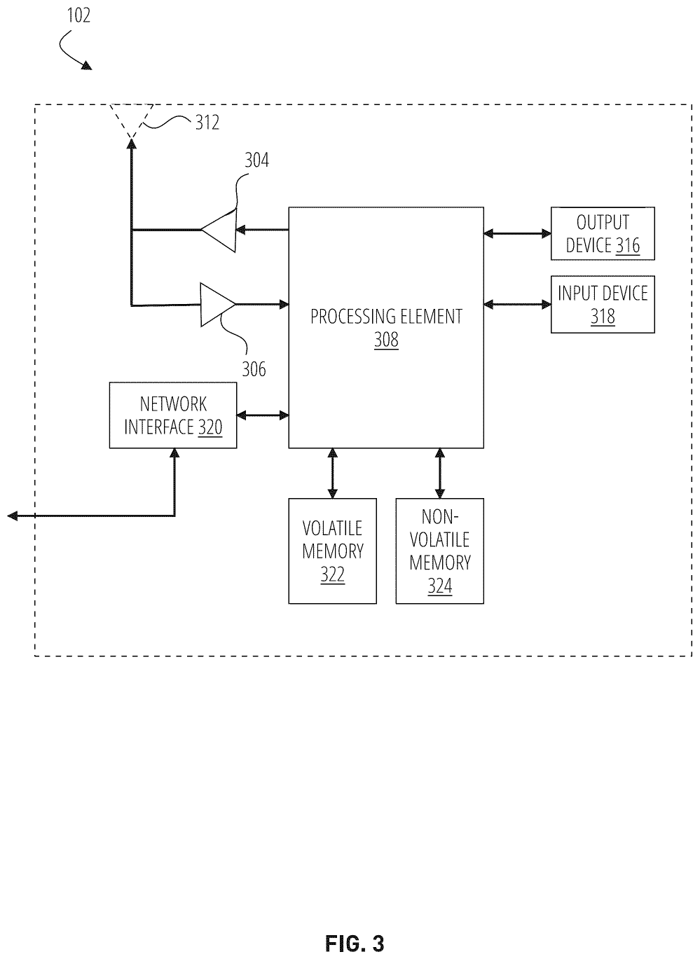

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “transcript data object” refers a data entity that describes a digital transcript including a sequence of text segments. The conversation may be conducted by two or more participants, which may be human participants and/or virtual participants, such as a virtual chat bot, etc. In some examples, a transcript data object may include one or more text strings (e.g., one or more utterances, one or more phrases, one or more sentences, and/or the like). Each text string may be represent one or more words spoken, transcribed, and/or otherwise output by a participant in a conversation. For example, the transcript data object 402 may include a plurality of utterances exchanged between a caller (e.g., a requesting service, etc.) and an agent (e.g., an agent service, etc.). As one example, the transcript data object 402 may include a call transcript between a member and an agent in a customer service environment. Other examples may include an exchange between a smart appliance and an appliance owner (e.g., a question-answer transcript, etc.), an interaction log between two software agents (e.g., a computer diagnosis report between a querying agent and a resolution agent, etc.), and/or the like.

In some examples, the transcript data object may be preprocessed to identify one or more participants to the transcript data object and/or assign a participant to each of the plurality of utterances. In some examples, the plurality of utterances may be aggregated to concatenate, merge, and/or otherwise stitch together adjacent utterances associated with a common participant. For example, a transcript data object may initially include a first utterance preceded by a first instance of a label (e.g., “Agent: Yes, I am happy to help.”) and a second utterance preceded by a second instance of the label (e.g., “Agent: Let me check our records.”). In such an example, the first utterance and the second utterance may be stitched together to form a single utterance text segment for consideration by a summarization process.

In some embodiments, the term “utterance text segment” refers to a data entity that describes a text segment from a transcript data object. A transcript data object, for example, may include a plurality of utterance text segments. Each utterance text segment may include any quantity of text, which may include letters, numbers, punctuation, special characters, spaces, and/or the like. In some examples, an utterance text segment may include one or more words and/or one or more phrases that are attributed to a particular participant of the transcript data object. For example, an utterance text segment may include a sequence of text and a participant label that identifies a participant of the transcript data object that output the sequence of text. In some examples, one or more utterance text segments from the plurality of utterance text segments may be leveraged to generate a transcript summary. The processing resources expended to generate the summary may increase with the number of considered utterance text segments. To improve processing efficiencies for a summarization process, some of the techniques of the present disclosure may filter the plurality of utterance text segment, using sentiment analysis techniques, to generate relevant utterances for the summarization process.

In some embodiments, the term “transcript summary” refers to a text-based data object that describes or otherwise summarizes at least a portion of a transcript data object. In some examples, a transcript summary may include a portion of utterance text segments from a transcript data object (e.g., an extractive summary, etc.). In such examples, the portion of utterance text segments may include one or more text segments that convey an overarching theme of the transcript data object or information relevant to one or more specific topics (e.g., an abstractive summary, etc.). For example, a transcript summary may include one or more utterance text segments that convey one or more caller intents, one or more agent resolutions, and/or the like. A transcript summary may be an extractive summary or an abstractive summary. An extractive summary may include a direct recitation or listing of one or more utterance text segments from a transcript data object. An abstractive summary may include one or more text segments (e.g., new text segments) that are derived from one or more utterance text segments from the transcript data object. In some examples, a transcript summary may be generated or otherwise output by a model, such as a machine learning summarization model, based on one or more relevant utterances from a transcript data object.

In some embodiments, the term “relevant utterance” refers to an utterance text segment from a transcript data object that is determined to be applicable to, indicative of, or relevant to a specific topic or categorization. For example, in a customer service domain, an utterance indicative of a caller intent or an agent resolution may be an example of a relevant utterance. In some examples, a relevant utterance may be an utterance that is selected for inclusion in a summary, such as a transcript summary. In some examples, a relevant utterance may be extracted from a plurality of utterance text segments in a transcript data object based on a plurality of emotion-based predictive relevancy scores, such as domain-specific relevancy predictions as described herein.

In some embodiments, the term “domain-specific relevancy prediction” refers to a data value indicating a likelihood that an utterance is applicable to, indicative of, or relevant to a specific topic or categorization. For example, a domain-specific relevancy prediction may indicate a likelihood that an utterance is a caller intent utterance (e.g., that an utterance expresses an intent of a caller for making a call). As another example, a domain-specific relevancy prediction may indicate a likelihood that an utterance is an agent resolution utterance (e.g., that an utterance expresses a resolution provided by an agent in response to a caller intent). As described herein, caller intent and agent resolution domain-specific relevancy predictions may be relevant to a specific domain, such as a customer service domain. In some examples, a domain-specific relevancy prediction may be indicated by a percentage or a decimal value (e.g., a value between zero and one). In some examples, a domain-specific relevancy prediction may be determined or otherwise generated using an emotion prediction vector generated for a particular utterance text segment. The emotion prediction vector may be generated using an emotion classification model.

In some embodiments, the term “emotion classification model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). An emotion classification model may include any type of model configured, trained, and/or the like to generate an emotion prediction vector, as described herein. An emotion classification model may include one or more of any type of machine learning model including one or more supervised, unsupervised, semi-supervised, and/or reinforcement learning models. In some embodiments, the emotion classification model may include multiple models configured to perform one or more different stages of a classification process.

In some examples, the emotion classification model may be configured (e.g., trained, etc.) to predict one or more emotion identifiers for text-based data input to the model. For example, an emotion classification model may receive an utterance text segment as an input and generate one or more predictions of one or more emotions conveyed by the utterance text segment. In some examples, an emotion classification model may generate an emotion prediction vector including a plurality of prediction values respectively corresponding to a plurality of emotion identifiers. Each prediction value, for example, may reflect a likelihood that a corresponding emotion identifier is associated with an input text segment. In some examples, an emotion classification model may be configured to generate probabilities for one or more emotions corresponding to or otherwise represented by one or more emojis (e.g., emotion identifiers). For example, the emotion classification model may include a DeepMoji model, and/or another sentiment analysis model. The emotion classification model may generate a set of probabilities for an emoji ontology. The emotion classification model may receive an utterance text segment and output a 64-dimensional vector including 64 probability values corresponding to 64 emojis. Each probability value may indicate a predicted likelihood that the utterance text segment is indicative of or otherwise associated with an emotion identifier, such as an emoji of the 64 emojis.

In some embodiments, the term “emotion prediction vector” refers to a data structure that describes a plurality of emotion prediction scores for a text segment, such as an utterance text segment from a transcript data object. For example, an emotion prediction vector may include a plurality of data values (e.g., real numbers, percentages, ratios, etc.) that respectively correspond to a plurality of defined emotions of an emotion ontology. Each data value, for instance, may include an emotion identifier probability reflective of a correspondence between a particular emotion and a text segment. In some examples, an emotion prediction vector may include a dimension for each of a plurality of defined emotions of the emotion ontology. For example, an emotion prediction vector may include 64-dimensional vector that defines 64 emotion prediction scores respectively corresponding to 64 defined emotion identifiers of the emotion ontology. In some examples, the emotion prediction vector (e.g., a 64-dimensional vector, etc.) may be output by an emotion classification model responsive to an utterance text segment. The output emotion prediction vector may define an emotion prediction score with respect to the utterance text segment for each defined emotion of the emotion ontology.

In some embodiments, the term “emotion prediction score” refers to a prediction value for a defined emotion within prediction space. An emotion prediction score, for example, may include a probability that a text segment, such as an utterance text segment, expresses or is otherwise associated with a particular emotion identifier. In some examples, an emotion prediction score may be represented by a number, percentage, ratio, and/or the like.

In some examples, a plurality of emotion prediction scores may be utilized to assign a predicted emotion identifier to an utterance text segment. For example, an emotion identifier with a highest emotion prediction score of the plurality of emotion prediction scores may be selected as a predicted emotion identifier for a given utterance text segment. This process may be performed iteratively until each utterance text segment of a transcript data object is associated with a respective emotion identifier. In this way, a transcript data object may include a plurality of utterance text segments that are each labelled with a corresponding channel name (e.g., “caller,” “agent,” and/or the like), and a corresponding predicted emotion identifier.

In some examples, a domain-specific relevancy prediction (e.g., a caller intent relevancy score, an agent resolution relevancy score, etc.) may be generated based on one or more category-specific emotion identifiers for a given category. For example, a caller intent relevancy prediction may be generated by adding together emotion prediction scores for each category-specific emotion identifier for a caller intent category. As another example, an agent resolution relevancy prediction may be generated by adding together emotion prediction scores for each category-specific emotion identifier for an agent resolution category.

In some embodiments, the term “emotion identifier” refers to a data value that represents a predefined emotion of an emotion ontology. An emotion identifier, for example, may include an emoji character, a hexadecimal vector, a decimal vector, a binary vector, and/or the like, that represents an emotion of an emotion ontology. In some examples, an emotion identifier may be reflective of a domain-specific summarization category that may help to derive transcript summaries that are tailored to target contexts within a prediction domain.

In some embodiments, the term “domain-specific summarization category” refers to a data entity that describes a category for an utterance text segment. A domain-specific summarization category, for example, may identify a target aspect of a transcript that is relevant to a summary of the transcript for a particular domain. By way of example, in a customer service domain, a first domain-specific summarization category may include a caller intent category that identifies an utterance text segment that is relevant to the caller's intent for a call transcript, a second domain-specific summarization category may include an agent resolution category that identifies an utterance text segment that is relevant to the agent's resolution for a call transcript, and/or the like. As described herein, a summary, such as a transcript summary, may be generated from a transcript based on one or more domain-specific summarization categories to ensure that one or more targeted aspects of the transcript are reflected by the summary. By way of example, using the customer service domain, a summary for a customer service call transcript may include one or more utterance text segments that express caller intent (e.g., as identified by a first domain specific summarization category, etc.) and/or one or more utterance text segments that express an agent resolution (e.g., as identified by a second domain specific summarization category, etc.).

In some embodiments, the term “category-specific emotion identifier” refers to an emotion identifier from an emotion ontology that corresponds to a domain-specific summarization category. For example, each domain-specific summarization category may be associated with one or more category-specific emotion identifiers that exhibit a predictive correlation to the domain-specific summarization category. In some examples, one or more operations may be performed to identify a set of category-specific emotion identifiers for each domain-specific summarization category of a prediction domain. As described herein, the set of category-specific emotion identifiers may be leveraged to generate domain-specific relevancy predictions for the utterance text segments of a transcript based on a sentiment analysis of the utterance text segments. This may allow sentiment analysis techniques to be leveraged for text summarization to improve upon traditional text summarization techniques with respect to accuracy, processing resource utilization, and explainability.

In some examples, each set of category-specific emotion identifiers may include a predetermined number (e.g., five, ten, one hundred, etc.) of emotion identifiers from an emotion ontology based on a predictive correlation between a plurality of emotion identifiers to the domain-specific summarization category (e.g., the highest ranked emotion identifiers, etc.). In addition, or alternatively, set of category-specific emotion identifiers may include a dynamic number of emotion identifiers based on a predictive correlation between a plurality of emotion identifiers to the domain-specific summarization category (e.g., all emotion identifiers with a predictive correlation that achieves a threshold, etc.).

As an example, using a 64-emotion identifier ontology in a dual (e.g., two) domain-specific summarization category domain, such as a customer service domain with dueling aspects of interest (e.g., caller intent and agent resolution), one or more emotion identifiers from the plurality of emotion identifiers may be extracted to create (i) a first subset of emotion identifiers associated with a first category (e.g., a caller intent category, etc.) and (ii) a second subset of emotion identifiers associated with a second category (e.g., an agent resolution category, etc.). In some examples, the plurality of emotion identifiers and/or historical data associated therewith may be processed at a predetermined frequency to update the first and second subsets based on historical correlations between the plurality of emotion identifiers and a target aspect of a transcript. At a first time, for example, a first subset of emotion identifiers may include an anger emoji, frustration emoji, confusion emoji, and/or the like that may have a predictive correlation to a caller intent category. In addition, or alternatively, a second subset of emotion identifiers may include a thumbs up emoji, a peace sign emoji, a winking emoji, and/or the like that may have a predictive correlation to an agent resolution category.

In some examples, category-specific emotion identifiers may be identified and/or iteratively refined for each domain-specific summarization category of a prediction domain based on a correlation between the plurality of emotion identifiers and a plurality of similarity scores between a plurality of historical utterances and training summaries. In some examples, a training summary may be generated using a training summarizer to automatically identify, refine, and/or monitor the sets of category-specific emotion identifiers for each domain-specific summarization category.

In some embodiments, the term “similarity score” refers to a data value that describes a degree of similarity between a pair of text segments. For example, a similarity score may describe a syntactic similarity between a first and second text segment. In some examples, a first text segment may include a training (e.g., synthetic and/or user, etc.) summary. A second text segment may include a historical utterance from a training transcript corresponding to the training summary. By way of example, a similarity score may include a cosine similarity between the first and second text segments.

In some embodiments, the term “historical utterance” refers to data entity that describes an utterance text segment from a training transcript. For example, a historical utterance may include a historical text segment from a training transcript that is stored in a training data store. A training data store, for example, may include a plurality of training transcripts the respectively correspond to a plurality of historical and/or synthetic call transcripts. Each training transcript may include a plurality of historical utterances that may be preprocessed to assign one or more training indicators, such as a historical emotion prediction vector.

In some embodiments, the term “historical emotion prediction vector” refers to a set of one or more values that respectively indicate one or more emotion probabilities for a historical utterance. In some examples, a historical emotion prediction vector may be generated by an emotion classification model, as described herein. A historical emotion prediction vector may be a data structure that describes a plurality of emotion prediction scores for an utterance text segment, such as a historical utterance from a training transcript. For example, a historical emotion prediction vector may include a plurality of one or more data values (e.g., real numbers, percentages, ratio, etc.) that respectively correspond to a plurality of defined emotions of an emotion ontology. Each data value, for instance, May include an indicated emotion identifier probability or likelihood reflective of a correspondence between a particular emotion and a historical utterance. In some examples, a historical emotion prediction vector may include a dimension for each of a plurality of defined emotions of the emotion ontology. For example, a historical emotion prediction vector may include 64-dimensional vector that defines 64 emotion prediction scores respectively corresponding to 64 defined emotion identifiers of the emotion ontology.

In some embodiments, the term “training summary” refers to a ground truth summary of a training transcript. A training summary may include a synthetic and/or user summary for the training transcript. A user summary, for example, may include a manual summary of the training transcript. A synthetic summary may include a model-based summary, such as an abstractive summary generated by a training summarizer. In some examples, a training summary may be generated based on one or more targeted aspects of a transcript, such as caller intent and/or agent resolution aspects in a customer service domain.

In some embodiments, the term “training summarizer” refers to a data entity that describes parameters, hyper-parameters, and/or defined operations of a rules-based and/or machine learning model (e.g., a model including at least one of one or more rule-based layers, one or more layers that depend on trained parameters, coefficients, and/or the like). A training summarizer may include a machine learning model trained and/or configured to generate a training summary from a training transcript, as described herein. A training summarizer may include one or more of any type of machine learning model including one or more supervised, unsupervised, semi-supervised, and/or reinforcement learning models. In some embodiments, the training summarizer may include multiple models configured to perform one or more different stages of a summarization process.

In some examples, a training summarizer may include a generative model configured to generate natural language text based on a generative prompt. For example, the generative model may include a large language model (LLM), such as a generative pre-trained transformer (GPT) model. In some examples, the generative model may include a GPT-3.5 model and/or any other machine learning model with generative capabilities. The generative model may be configured to generate a training summary based on a generative prompt (e.g., a no shot prompt, a few shot prompt, etc.). The generative prompt, for example, may include instructions to generate an abstractive and/or extractive summary of a training transcript based one or more summarization criteria. The summarization criteria, for example, may define the one or more targeted aspects of the transcript, a text length, a hallucination limit, and/or the like. In some examples, the generative prompt may include one or more summary examples for formatting the training summary.

In some embodiments, a training summarizer may receive a training transcript and generative prompt as an input and, in response to the generative prompt, output a training summary for the training transcript. In some examples, the training transcript may be preprocessed to remove personal identification information (PII) before providing the training transcript to the training summarizer.

In some examples, a training summarizer may include an LLM that is finetuned using a domain-specific dataset. By way of example, a training summarizer may be finetuned over a training data store, as described herein. In this manner, a training summarizer may be utilized to generate one or more training summaries tailored to a specific type of content, such as caller intent and agent resolution in a customer service domain. In some examples, the one or more training summaries may be stored in the training data store to continuously augment the training data store with relevant training samples.

In some embodiments, the term “category-relevant subset of emotion prediction scores” refers to a subset of emotion prediction scores that correspond to a set of category-specific emotion identifiers of a domain-specific summarization category. For example, the category-relevant subset of emotion prediction scores may include a subset of emotion prediction scores from an emotion prediction vector for an utterance text segment. In some examples, each emotion prediction score of a category-relevant subset may be aggregated to determine a domain-specific relevancy prediction for a particular domain-specific summarization category. The domain-specific relevancy prediction may be indicative of a likelihood that the utterance text segment expresses a sentiment associated with the specific category. As an example, an emotion prediction vector for an utterance text segment may include 64 emotion prediction scores. A subset of the 64 emotion prediction scores may be identified as prediction scores indicative of a caller intent. The subset of scores may then be added together to determine the domain-specific relevancy prediction, which may indicate a likelihood that the utterance text segment is indicative of caller intent.

In some embodiments, the term “relevancy threshold” refers to a configurable data parameter for filtering one or more utterance text segments from a transcript data object. A relevancy threshold may be a static and/or learned parameter that may be iteratively modified to optimize the performance of an emotion-based summarization pipeline. For example, the relevancy threshold may be increased to improve a predictive accuracy of the emotion-based summarization pipeline, decreased to improve a scope of coverage of the emotion-based summarization pipeline, and/or the like. In some examples, the relevancy threshold may depend on a summarization domain. For instance, the relevancy threshold may include a first data value (e.g., 0.9, 0.95, etc.) for a healthcare domain associated with one or more compliance standards that is greater than a relevancy threshold of a second data value (e.g., 0.7, 0.75, etc.) for a consumer product domain associated with one or more less stringent compliance standards.

In some examples, a domain-specific relevancy prediction for an utterance text segment may be compared to a relevancy threshold to determine whether the utterance text segment is relevant to a domain-specific summarization category (e.g., a caller intent category, an agent resolution category, and/or the like). If the domain-specific relevancy prediction satisfies the relevancy threshold (e.g., is greater than or equal to), it may be determined that the associated utterance text segment is relevant to a domain-specific summarization category. As an example, an utterance text segment such as “Can you help me recover my password?” may have a domain-specific relevancy prediction (e.g., a caller intent score) of 0.95, which may satisfy a relevancy threshold (e.g., for caller intent) of 0.90. Accordingly, it may be determined that the utterance text segment is expressive of a caller intent. In some examples, a plurality of relevant utterances with domain-specific relevancy predictions that achieve a respective relevancy threshold may be provided to a machine learning summarization model to generate a transcript summary for a transcript data object.

In some examples, different relevancy thresholds may be used for one or more domain-specific summarization categories of a prediction domain. For instance, the relevancy threshold may include a first data value (e.g., 0.9, 0.95, etc.) for a first domain-specific summarization category (e.g., caller intent, etc.) and a relevancy threshold of a second data value (e.g., 0.8, 0.85, etc.) for a second domain-specific summarization category (e.g., agent resolution, etc.). In this manner, a transcript summary may be dynamically modified to represent different targeted aspects of a transcript data object by changing the relevancy thresholds associated therewith.

In some embodiments, the term “machine learning summarization model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning summarization model may include a machine learning model configured, trained, and/or the like to generate a transcript summary from a transcript data object, as described herein. A machine learning summarization model may include one or more of any type of machine learning model including one or more supervised, unsupervised, semi-supervised, and/or reinforcement learning models. In some embodiments, the machine learning summarization model may include multiple models configured to perform one or more different stages of a summarization process.

In some examples, a machine learning summarization model may include a generative model configured to generate natural language text based on a generative prompt. For example, the generative model may include an LLM, such as a GPT model. The machine learning summarization model, for example, may include a same or different architecture as the training summarizer. The machine learning summarization model may be configured to generate a transcript summary based on a generative prompt (e.g., a no shot prompt, few shot prompt, etc.). The generative prompt, for example, may include instructions to generate an abstractive and/or extractive summary of a transcript data object based one or more summarization criteria. The summarization criteria, for example, may define the one or more targeted aspects of the transcript data object, a text length, a hallucination limit, and/or the like. In some examples, the generative prompt may include one or more summary examples for formatting the transcript summary. In some examples, the generative prompt may include one or more relevant utterances from the transcript data object.

In some examples, a machine learning summarization model may include an LLM that is finetuned using a domain-specific dataset. By way of example, a machine learning summarization model may be finetuned over a training data store, as described herein. In this manner, a machine learning summarization model may be utilized to generate one or more transcript summaries tailored to a specific type of content, such as caller intent and agent resolution in a customer service domain, and/or the like. In some examples, a transcript summary may be stored in the training data store to continuously augment the training data store with relevant training samples.

In some embodiments, a machine learning summarization model receives one or more relevant utterances from the transcript data object and a generative prompt as an input, and based on the generative prompt, outputs a transcript summary based on the one or more relevant utterances. The one or more relevant utterances, for example, may be identified using the domain-specific relevancy predictions, as described herein. In some examples, the transcript summary may be an abstractive summary. In some examples, a machine learning summarization model may be configured to output a specific quantity of tokens (e.g., words based on a text length criterion, etc.). For example, a machine learning summarization model may output an abstractive summary with a maximum token length of 512 tokens. As described herein, utilizing a machine learning summarization model to generate an abstractive summary based on the one or more relevant utterances may provide one or more advantages when compared to conventional techniques. For example, generating a summary based on previously identified relevant utterances may provide improved, more tailored, and effective summarizations when compared to generating a summary based on an entire transcript data object.

In some examples, one or more utterances with domain-specific relevancy predictions that satisfy a respective relevancy threshold may be input to the machine learning summarization model for the creation of a transcript summary based on the one or more utterances. Additionally, or alternatively, the transcript summary may be based on one or more utterances before and/or after the one or more utterances with domain-specific relevancy predictions that satisfy the threshold. For example, a first utterance may have a domain-specific relevancy prediction that satisfies a relevancy threshold. The first utterance in addition to one or more second utterances (n1) preceding the first utterance and one or more third utterances (n2) subsequent to the first utterance may be used to create a transcript summary (e.g., an extractive summary). In such examples, the quantities of adjacent utterances (n1 and n2) may be preconfigured or based on respective relevancy thresholds for the adjacent utterances.

In some examples, one or more filtering operations may be performed to remove or otherwise filter one or more words, terms, and/or phrases from the one or more utterance text segments. The one or more filtering operations, for example, may be performed on the one or more relevant utterances selected for input to the machine learning summarization model. For example, prior to inputting the one or more utterances to the machine learning summarization model, the one or more relevant utterances may be filtered to remove one or more one or more words, terms, and/or phrases including predefined filler words (e.g., “uh,” “um,” “actually,” and/or the like), stop words (e.g., prepositions, articles, conjunctions, pronouns, verbs, and/or the like), domain-specific words, and/or the like. Additionally, or alternatively, the one or more filtering operations may include removing various sections of a transcript data object (e.g., a beginning section, a middle section, an ending section). In such examples, various sections may be defined or otherwise preconfigured based on a transcript length (e.g., a quantity of utterances in a call transcript). For example, a call transcript may be divided into thirds. Accordingly, if a call transcript includes 999 utterances, a beginning section of the call transcript may be defined as including utterances 1 through 333, a middle section of the call transcript may be defined as including utterances 334 through 666, and an end section of the call transcript may be defined as including utterances 667 through 999.

In some examples, one or more sequence verification and/or reordering operations may be performed to verify or otherwise ensure that the one or more relevant utterances selected for input to the machine learning summarization model are correctly sequenced (e.g., correctly ordered, ordered chronologically, etc.). In some examples, the one or more sequence verification and/or reordering operations may be performed by checking an utterance identifier for each of the one or more utterance text segments to confirm that an utterance text segment ordering is sequential. For example, a chronologically first utterance text segment of a transcript data object may have an utterance identifier of “1,” a chronologically second utterance text segment of the transcript data object may have an utterance identifier of “2,” and so forth. Additionally, or alternatively, each utterance text segment may have a timestamp, which may be utilized to order or reorder utterance text segments prior to input to the machine learning model.

In some examples, a transcript summary output by a machine learning summarization model may be contextualized based on the contextual data (e.g., emotion prediction vector, etc.) leveraged to filter the plurality of relevant text utterances from the transcript data object. For example, the transcript summary may be contextualized by a transcript sentiment.

In some embodiments, the term “transcript sentiment” refers to a data entity that describes an overarching emotion or theme of a transcript data object or a portion of a transcript data object. For example, a transcript sentiment may indicate a sentiment or emotion associated with any portion of a transcript data object, such as an ending portion of a transcript data object (e.g., for the last ten utterance text segments of a transcript data object). In some examples, a transcript sentiment may include one of one or more overall sentiment emotion identifiers. Each overall sentiment emotion identifier, for example, may include an emotion identifier from the plurality of emotion identifiers of an emotion ontology that is predesignated for representing an overall sentiment option for a transcript data object. By way of example, the overall sentiment emotion identifiers may include a negative emotion identifier (e.g., frowning emoji, etc.), a neutral emotion identifier (e.g., a neutral face emoji, etc.), a positive emotion identifier (e.g., smiling emoji, etc.), and/or the like. In some examples, a transcript sentiment may be generated based on a concluding subset of emotion prediction scores corresponding to one or more concluding utterance text segments of a transcript data object.

In some embodiments, the term “concluding subset of emotion prediction scores” refers to a plurality of emotion prediction scores for each concluding utterance of a transcript data object. In some examples, the concluding subset of emotion prediction scores may include a highest emotion prediction score from an emotion prediction vector for each of the concluding utterances. In addition, or alternatively, the concluding subset of emotion prediction scores may include the emotion prediction vector for each of the concluding utterances.

In some embodiments, the term “concluding utterances” refers to the subset of utterance text segments from a transcript data object that is used to identify a transcript sentiment. The number of concluding utterances may be configurable. In some examples, the concluding utterances may include the last ten (e.g., last in temporal order) utterance text segments from the transcript data object. In some examples, a concluding subset of emotion prediction scores may include ten of the highest emotion prediction scores respectively corresponding to the last ten utterance text segments from the transcript data object. In addition, or alternatively, the concluding subset of emotion prediction scores may include ten emotion prediction vectors respectively corresponding to the last ten utterance text segments from the transcript data object. In such a case, a transcript sentiment may be determined based on one or more sentiment bucket scores determined from the emotion prediction vectors.

In some embodiments, the term “sentiment bucket score” refers to a data value that describes an aggregate value of emotion prediction scores associated with a particular sentiment bucket. For example, a first sentiment bucket score (e.g., a positive sentiment bucket score) may be determined by aggregating (e.g., adding, etc.) emotion prediction scores for a first plurality of emotion identifiers in a first sentiment bucket (e.g., a positive sentiment bucket). A second sentiment bucket score (e.g., a negative sentiment bucket score) may be determined by aggregating (e.g., adding, etc.) emotion prediction scores for a second plurality of emotion identifiers in a second sentiment bucket (e.g., a negative sentiment bucket). A third sentiment bucket score (e.g., a neutral sentiment bucket score) may be determined by aggregating (e.g., adding, etc.) emotion prediction scores for a third plurality of emotion identifiers in a third sentiment bucket (e.g., a neutral sentiment bucket). As described herein, the emotion prediction scores utilized to determine a sentiment bucket score may be taken from a quantity of concluding utterances of a transcript data object.

In some embodiments, the term “bucket subset” refers to a subset of emotion identifiers that are associated with a particular sentiment bucket. For example, a first bucket subset of emotion identifiers may be selected for a first sentiment bucket (e.g., a positive sentiment bucket). The first bucket subset may include emotion identifiers indicative of one or more positive emotions. A second bucket subset of emotion identifiers may be selected for a second sentiment bucket (e.g., a negative sentiment bucket). The second bucket subset may include emotion identifiers indicative of one or more negative emotions. A third bucket subset of emotion identifiers may be selected for a third sentiment bucket (e.g., a neutral sentiment bucket). The third bucket subset may include emotion identifiers indicative of one or more neutral emotions.

In some embodiments, the term “bucket-specific emotion identifier” refers to an emotion identifier that is categorized or otherwise grouped in a bucket subset. For example, a laughing emoji may be an example of a bucket-specific emotion identifier for a positive sentiment bucket, an angry emoji may be an example of a bucket-specific emotion identifier for a negative sentiment bucket, etc. In some examples, each emotion identifier of an emotion ontology may be categorized as a bucket-specific emotion identifier of a bucket subset for one of the overall sentiment emotion identifiers designated for a prediction domain.

### IV. OVERVIEW

Various embodiments of the present disclosure address technical challenges related to machine learning, including machine learning-based text comprehension techniques. In a variety of data-intensive applications, machine learning techniques may be applied to interpret large natural language text corpuses, such as transcript data objects, and make predictive inferences based on insights derived therefrom. In some cases, different machine learning pipelines may be applied to derive different insights from text. For example, sentiment analysis-based models may be applied to understand an emotion or sentiment underlying text, which may help a computer better understand and react to the semantic meaning of the text. Other, traditionally separate, models include summarization models that may be applied to extract and summarize targeted aspects from text, which may help a computer better understand and react to targeted aspects of the text. Each technique requires significant computing resources such that applying them separately may be prohibitive for computing environments without access to unconstrained computing resources.

Some techniques of the present disclosure present a multi-stage, sentiment-based text interpretation process that enables the generation of both sentiment and summarization insights from text at a fraction of the computation cost traditionally required. To do so, the multi-stage, sentiment-based text interpretation process includes a sentiment analysis stage that is adapted to text summarization. The adapted sentiment analysis stage is integrated within a machine learning summarization pipeline to filter, rank, and selectively input portions of text from a transcript data object to a summarization model. By doing so, sentiment analysis may be applied to focus a machine learning model on targeted aspects of a transcript data object. This, in turn, may lead to more comprehensive text summarizations and reduce the computing resources expended by a summarization model to process large text inputs. At the same time, the sentiment insights derived during the adapted sentiment analysis stage may be reused to augment summaries output by the summarization process. Ultimately, this results in comprehensive text insights at a fraction of the computational cost traditionally required, while improving the accuracy, content, and coverage of the underlying machine learning summarization techniques.

Examples of technologically advantageous embodiments of the present disclosure include improved machine learning techniques that leverage improved model pipeline to improve both the performance and resource usage of machine learning models, among other examples. Other technical improvements and advantages may be realized by one of ordinary skill in the art.

### V. EXAMPLE SYSTEM OPERATIONS

As indicated, various embodiments of the present disclosure make important technical contributions to machine learning technologies. In particular, systems and methods are disclosed herein that enable the generation of comprehensive text insights by integrating sentiment analysis with machine learning summarization techniques. When compared to traditional techniques, some of the techniques of the present disclosure provide improved textual summaries at a fraction of the computational cost, among other technical advantages.

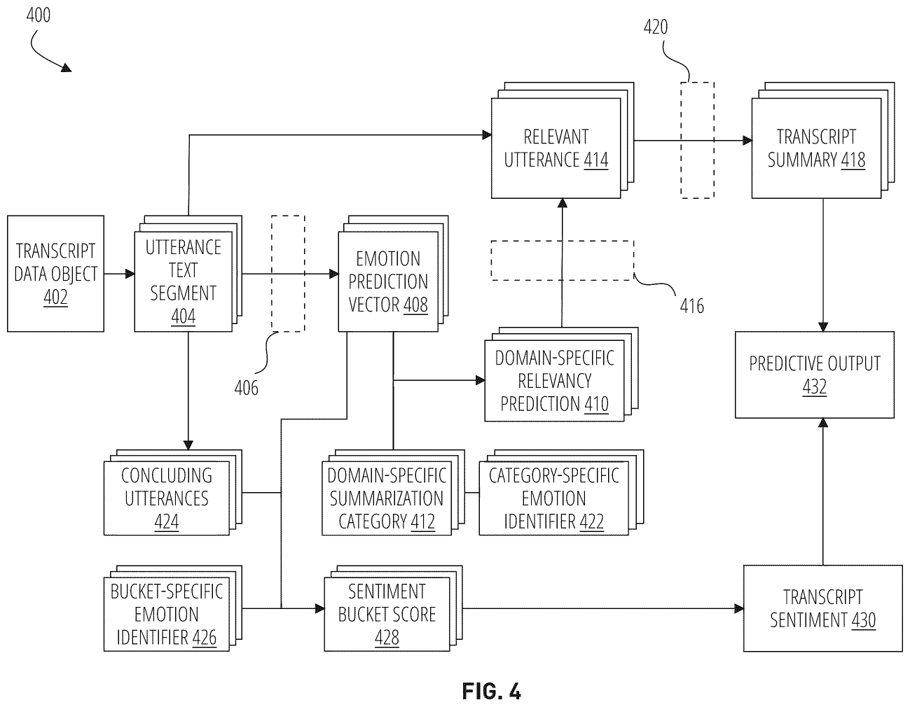

FIG. 4 is a dataflow diagram 400 showing example data structures and modules for implementing a multi-stage, sentiment-based text interpretation process in accordance with some embodiments discussed herein. As depicted, using some of the techniques of the present disclosure, an augmented transcript summary 418 may be extracted from a transcript data object 402 using sentiment analysis to streamline traditionally resource intensive summarization processes. Traditionally, sentiment analysis is used as an ancillary and independent computing task in addition to a text summarization task that is performed to provide context to a transcript summary 418 without improving summarization process itself. As shown by the dataflow diagram 400, the multi-stage, sentiment-based text interpretation process of the present disclosure may integrate two traditionally independent processes, sentiment analysis and text summarization, to improve each process relative to traditional techniques. By doing so, some techniques of the present disclosure may improve the accuracy, coverage, and reliability of computer-based text summarization, while reducing the computing resources expended.

In some embodiments, a transcript data object 402 is received. In some examples, a plurality of utterance text segments 404 may be identified from the transcript data object 402. In some examples, one or more utterance text segments 404 may be removed from the transcript data object 402 based on one or more of a location of the one or more utterance text segments 404 within the transcript data object 402, a content-based categorization of the one or more utterance text segments, and/or the like. In addition, or alternatively, the utterance text segments 404 may be further filtered based on a sentiment analysis of the utterance text segments 404. For example, each of the utterance text segments 404 may be provided as an input to an emotion classification model 406 to receive an emotion prediction vector 408. The utterance text segments 404 may be provided to the emotion classification model 406 before a summarization process to streamline the summarization process by identifying relevant utterances 414 based on sentiment analysis.

In some embodiments, the transcript data object 402 is a data entity that describes a digital transcript including a sequence of text segments. The digital transcript, for example, may transcribe a conversation between two or more participants, which may be human participants and/or virtual participants, such as a virtual chat bot, etc. In some examples, the transcript data object 402 may include one or more text strings (e.g., one or more utterances, one or more phrases, one or more sentences, and/or the like). Each text string may represent of one or more words spoken, transcribed, and/or otherwise output by a participant in a conversation. For example, the transcript data object 402 may include a plurality of utterances exchanged between a caller (e.g., a requesting service, etc.) and an agent (e.g., an agent service, etc.). As one example, the transcript data object 402 may include a call transcript between a member and an agent in a customer service environment. Other examples may include an exchange between a smart appliance and an appliance owner (e.g., a question-answer transcript, etc.), an interaction log between two software agents (e.g., a computer diagnosis report between a querying agent and a resolution agent, etc.), and/or the like.

In some examples, the transcript data object 402 may be preprocessed to identify one or more participants to the transcript data object 402 and/or assign a participant to each of the plurality of utterances. In some examples, the plurality of utterances may be aggregated to concatenate, merge, and/or otherwise stitch together adjacent utterances associated with a common participant. For example, a transcript data object 402 may initially include a first utterance preceded by a first instance of a label (e.g., “Agent: Yes, I am happy to help.”) and a second utterance preceded by a second instance of the label (e.g., “Agent: Let me check our records.”). In such an example, the first utterance and the second utterance may be stitched together to form a single utterance text segment 404 for consideration by a summarization process.

In some embodiments, an utterance text segment 404 is a data entity that describes a text segment from a transcript data object 402. A transcript data object 402, for example, may include a plurality of utterance text segments 404. Each utterance text segment 404 may include any quantity of text, which may include letters, numbers, punctuation, special characters, spaces, and/or the like. In some examples, an utterance text segment 404 may include one or more words and/or one or more phrases that are attributed to a particular participant of the transcript data object 402. For example, an utterance text segment 404 may include a sequence of text and a participant label that identifies a participant of the transcript data object 402 that output the sequence of text. In some examples, one or more utterance text segments 404 from the plurality of utterance text segments 404 may be leveraged to generate a transcript summary 418. The processing resources expended to generate the summary may increase with the number of considered utterance text segments 404. To improve processing efficiencies for a summarization process, some of the techniques of the present disclosure may filter the plurality of utterance text segment 404, using sentiment analysis techniques, to generate relevant utterances 414 for the summarization process.

In some embodiments, an emotion prediction vector 408 is received for each utterance text segment 404 from the transcript data object 402. The emotion prediction vector 408, for example, may be received from an emotion classification model 406. In some examples, the emotion prediction vector 408 may include a plurality of emotion prediction scores respectively corresponding to a plurality of emotion identifiers.

In some embodiments, an emotion classification model 406 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The emotion classification model 406 may include any type of model configured, trained, and/or the like to generate an emotion prediction vector 408, as described herein. The emotion classification model 406 may include one or more of any type of machine learning model including one or more supervised, unsupervised, semi-supervised, and/or reinforcement learning models. In some embodiments, the emotion classification model 406 may include multiple models configured to perform one or more different stages of a classification process.

In some examples, the emotion classification model 406 may be configured (e.g., trained, etc.) to predict one or more emotion identifiers for text-based data input to the model. For example, the emotion classification model 406 may receive an utterance text segment 404 as an input and generate one or more predictions of one or more emotions conveyed by the utterance text segment 404. In some examples, the emotion classification model 406 may generate the emotion prediction vector 408 including a plurality of prediction values respectively corresponding to a plurality of emotion identifiers. Each prediction value, for example, may reflect a likelihood that a corresponding emotion identifier is associated with an input text segment. In some examples, the emotion classification model 406 may be configured to generate probabilities for one or more emotions corresponding to or otherwise represented by one or more emojis (e.g., emotion identifiers, etc.). For example, the emotion classification model 406 may include a DeepMoji model, and/or another sentiment analysis model. The emotion classification model 406 may generate a set of probabilities for an emoji ontology. The emotion classification model 406 may receive an utterance text segment 404 and output a 64-dimensional vector including 64 probability values corresponding to 64 emojis. Each probability value may indicate a predicted likelihood that the utterance text segment 404 is indicative of or otherwise associated with an emotion identifier, such as an emoji of the 64 emojis.

In some embodiments, the emotion prediction vector 408 refers to a data structure that describes a plurality of emotion prediction scores for a text segment, such as an utterance text segment 404 from the transcript data object 402. For example, the emotion prediction vector 408 may include a plurality of data values (e.g., real numbers, percentages, ratios, etc.) that respectively correspond to a plurality of defined emotions of an emotion ontology. Each data value, for instance, may include an emotion identifier probability reflective of a correspondence between a particular emotion and a text segment. In some examples, the emotion prediction vector 408 may include a dimension for each of a plurality of defined emotions of the emotion ontology. For example, an emotion prediction vector may include 64-dimensional vector that defines 64 emotion prediction scores respectively corresponding to 64 defined emotion identifiers of the emotion ontology. In some examples, the emotion prediction vector 408 (e.g., a 64-dimensional vector, etc.) may be output by the emotion classification model 406 responsive to an utterance text segment 404. The output emotion prediction vector 408 may define an emotion prediction score with respect to the utterance text segment 404 for each defined emotion of the emotion ontology.

In some embodiments, an emotion prediction score is a prediction value for a defined emotion within prediction space. An emotion prediction score, for example, may include a probability that a text segment, such as an utterance text segment 404, expresses or is otherwise associated with a particular emotion identifier. In some examples, an emotion prediction score may be represented by a number, percentage, ratio, and/or the like.

In some examples, a plurality of emotion prediction scores may be utilized to assign a predicted emotion identifier to an utterance text segment 404. For example, an emotion identifier with a highest emotion prediction score of the plurality of emotion prediction scores may be selected as a predicted emotion identifier for a given utterance text segment 404. This process may be performed iteratively until each utterance text segment of a transcript data object 402 is associated with a respective emotion identifier. In this way, a transcript data object 402 may include a plurality of utterance text segments 404 that are each labelled with a corresponding participant and predicted emotion identifier.

In some embodiments, an emotion identifier is a data value that represents a predefined emotion of an emotion ontology. An emotion identifier, for example, may include an emoji character, a hexadecimal vector, a decimal vector, a binary vector, and/or the like, that represents an emotion of an emotion ontology. In some examples, an emotion identifier may be reflective of a domain-specific summarization category 412 that may help to derive transcript summaries 418 that are tailored to target contexts within a prediction domain.

In some embodiments, the emotion prediction scores of an emotion prediction vector 408 may be leveraged to generate a domain-specific relevancy prediction 410 (e.g., a caller intent relevancy score, an agent resolution relevancy score, etc.) for an utterance text segment 404. For example, the domain-specific relevancy prediction 410 may be based on one or more category-specific emotion identifiers 422 for a given domain-specific summarization category. By way of example, domain-specific summarization categories may include caller intent and agent resolution categories for a customer service domain. In such a case, a domain-specific relevancy prediction 410 may be generated by adding together emotion prediction scores for each category-specific emotion identifier for a caller intent category. As another example, an agent resolution relevancy prediction may be generated by adding together emotion prediction scores for each category-specific emotion identifier for an agent resolution category.

In some embodiments, a domain-specific relevancy prediction 410 is generated for the utterance text segment 404 based on a category-relevant subset of emotion prediction scores that correspond to one or more category-specific emotion identifiers 422 of the plurality of emotion identifiers associated with a domain-specific summarization category 412. In some examples, the domain-specific relevancy prediction 410 may include of a probability that the utterance text segment 404 is associated with (i) an expression of intent, (ii) an expression of a resolution, and/or (iii) an expression of contextual information. In some examples, a domain-specific relevancy prediction 410 may include an aggregation of the category-relevant subset of emotion prediction scores for a particular domain-specific summarization category 412. In some examples, a domain-specific relevancy prediction 410 may be generated for each domain-specific summarization category 412 of a plurality of domain-specific summarization categories 412 of a prediction domain.

In some embodiments, a domain-specific summarization category 412 is a data entity that describes a category for the utterance text segment 404. The domain-specific summarization category 412, for example, may identify a target aspect of a transcript that is relevant to a summary of the transcript for a particular domain. By way of example, in a customer service domain, a first domain-specific summarization category may include a caller intent category that identifies an utterance text segment 404 that is relevant to the caller's intent for a call transcript, a second domain-specific summarization category may include an agent resolution category that identifies an utterance text segment 404 that is relevant to the agent's resolution for a call transcript, and/or the like. As another example, in a computer activity monitoring domain, a first domain-specific summarization category may include a performance query category that identifies an utterance text segment 404 that is relevant to a performance query for diagnosing a computing anomaly, a second domain-specific summarization category may include a performance response category that identifies an utterance text segment 404 that is relevant to the performance log corresponding to a performance query, and/or the like.

As described herein, a summary, such as the transcript summary 418, may be generated from a transcript based on one or more domain-specific summarization categories 412 to ensure that one or more targeted aspects of the transcript are reflected by the summary. By way of example, using the customer service domain, a summary for a customer service call transcript may include one or more utterance text segments 404 that express caller intent (e.g., as identified by a first domain specific summarization category, etc.) and/or one or more utterance text segments 404 that express an agent resolution (e.g., as identified by a second domain specific summarization category, etc.). As another example, using the computer activity monitoring domain, a summary for a performance data log may include one or more utterance text segments 404 that express performance queries (e.g., as identified by a first domain specific summarization category, etc.) and/or one or more utterance text segments 404 that express a performance response (e.g., as identified by a second domain specific summarization category, etc.).

In some embodiments, a category-specific emotion identifier 422 is an emotion identifier from an emotion ontology that corresponds to a domain-specific summarization category 412. For example, each domain-specific summarization category 412 may be associated with one or more category-specific emotion identifiers 422 that exhibit a predictive correlation to the domain-specific summarization category 412. In some examples, one or more operations may be performed to identify a set of category-specific emotion identifiers 422 for each domain-specific summarization category 412 of a prediction domain. As described herein, the set of category-specific emotion identifiers 422 may be leveraged to generate domain-specific relevancy predictions 410 for the utterance text segments 404 of a transcript data object 402 based on a sentiment analysis of the utterance text segments 404. This may allow sentiment analysis techniques to be leveraged for text summarization to improve upon traditional text summarization techniques with respect to accuracy, processing resource utilization, and explainability.

In some embodiments, a category-relevant subset of emotion prediction scores is a subset of emotion prediction scores from an emotion prediction vector 408 that correspond to a set of category-specific emotion identifiers 422 of a domain-specific summarization category 412. For example, the category-relevant subset of emotion prediction scores may include a subset of emotion prediction scores from an emotion prediction vector 408 for an utterance text segment 404. In some examples, each emotion prediction score of a category-relevant subset may be aggregated to determine a domain-specific relevancy prediction 410 for a particular domain-specific summarization category 412. The domain-specific relevancy prediction 410 may be indicative of a likelihood that the utterance text segment expresses a sentiment associated with the specific category. As an example, an emotion prediction vector 408 for an utterance text segment 404 may include 64 emotion prediction scores. A subset of the 64 emotion prediction scores may be identified as prediction scores indicative of a caller intent. The subset of scores may then be added together to determine the domain-specific relevancy prediction 410, which may indicate a likelihood that the utterance text segment 404 is indicative of caller intent.

In some embodiments, a domain-specific relevancy prediction 410 is a data value indicating a likelihood that an utterance is applicable to, indicative of, or relevant to a specific topic or categorization. For example, the domain-specific relevancy prediction 410 may indicate a likelihood that an utterance is a caller intent utterance (e.g., that an utterance expresses an intent of a caller for making a call). As another example, a domain-specific relevancy prediction 410 may indicate a likelihood that an utterance is an agent resolution utterance (e.g., that an utterance expresses a resolution provided by an agent in response to a caller intent). In some examples, a domain-specific relevancy prediction 410 may be indicated by a percentage or a decimal value (e.g., a value between zero and one). In some examples, the domain-specific relevancy prediction 410 may be determined or otherwise generated using the emotion prediction vector 408 generated for a particular utterance text segment 404 (e.g., as generated using the emotion classification model 406).

In some embodiments, an utterance text segment 404 is identified as a relevant utterance 414 from the transcript data object 402 based on a comparison between the domain-specific relevancy prediction 410 and a relevancy threshold 416.

In some embodiments, a relevant utterance 414 is an utterance text segment 404 from a transcript data object 402 that is determined to be applicable to, indicative of, or relevant to a specific topic or categorization, such as a domain-specific summarization category 412. For example, in a customer service domain, an utterance indicative of a caller intent or an agent resolution may be an example of a relevant utterance 414. In some examples, a relevant utterance 414 may be an utterance that is selected for inclusion in a summary, such as a transcript summary 418. In some examples, a relevant utterance 414 may be extracted from a plurality of utterance text segments 404 in a transcript data object 402 based on a plurality of emotion-based predictive relevancy scores, such as domain-specific relevancy predictions 410 as described herein. In some examples, each relevant utterance 414 may be extracted based on a comparison between the domain-specific relevancy prediction 410 and a relevancy threshold 416.

In some embodiments, a relevancy threshold 416 is a configurable data parameter for filtering one or more utterance text segments 404 from a transcript data object 402. A relevancy threshold 416 may be a static and/or learned parameter that may be iteratively modified to optimize the performance of an emotion-based summarization pipeline. For example, the relevancy threshold 416 may be increased to improve a predictive accuracy of the emotion-based summarization pipeline, decreased to improve a scope of coverage of the emotion-based summarization pipeline, and/or the like. In some examples, the relevancy threshold 416 may depend on a summarization domain. For instance, the relevancy threshold 416 may include a first data value (e.g., 0.9, 0.95, etc.) for a healthcare domain associated with one or more compliance standards that is greater than a relevancy threshold 416 of a second data value (e.g., 0.7, 0.75, etc.) for a consumer product domain associated with one or more less stringent compliance standards.

In some examples, a domain-specific relevancy prediction 410 for an utterance text segment 404 may be compared to a relevancy threshold 416 to determine whether the utterance text segment 404 is relevant to a domain-specific summarization category 412 (e.g., a caller intent category, an agent resolution category, and/or the like). If the domain-specific relevancy prediction 410 satisfies the relevancy threshold 416 (e.g., is greater than or equal to), it may be determined that the associated utterance text segment 404 is relevant to a domain-specific summarization category 412. As an example, an utterance text segment 404 such as “Can you help me recover my password?” may have a domain-specific relevancy prediction 410 (e.g., a caller intent score) of 0.95, which may satisfy a relevancy threshold 416 (e.g., for caller intent) of 0.90. Accordingly, it may be determined that the utterance text segment 404 is expressive of a caller intent. In some examples, a plurality of relevant utterances 414 with domain-specific relevancy predictions 410 that achieve a respective relevancy threshold 416 may be provided to a machine learning summarization model 420 to generate a transcript summary 418 for a transcript data object 402.

In some examples, different relevancy thresholds 416 may be used for one or more domain-specific summarization categories 412 of a prediction domain. For instance, the relevancy threshold 416 may include a first data value (e.g., 0.9, 0.95, etc.) for a first domain-specific summarization category (e.g., caller intent, etc.) and a relevancy threshold 416 of a second data value (e.g., 0.8, 0.85, etc.) for a second domain-specific summarization category (e.g., agent resolution, etc.). In this manner, the transcript summary 418 may be dynamically modified to represent different targeted aspects of a transcript data object 402 by changing the relevancy thresholds 416 associated therewith.

In some embodiments, a performance of a machine learning summarization operation is initiated based on the utterance text segment 404. For example, the relevant utterance 414 may be input to a machine learning summarization model 420 to receive a transcript summary 418 for the transcript data object 402.

In some embodiments, the machine learning summarization model 420 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning summarization model 420 may include a machine learning model configured, trained, and/or the like to generate a transcript summary 418 from a transcript data object 402, as described herein. The machine learning summarization model 420 may include one or more of any type of machine learning model including one or more supervised, unsupervised, semi-supervised, and/or reinforcement learning models. In some embodiments, the machine learning summarization model 420 may include multiple models configured to perform one or more different stages of a summarization process.

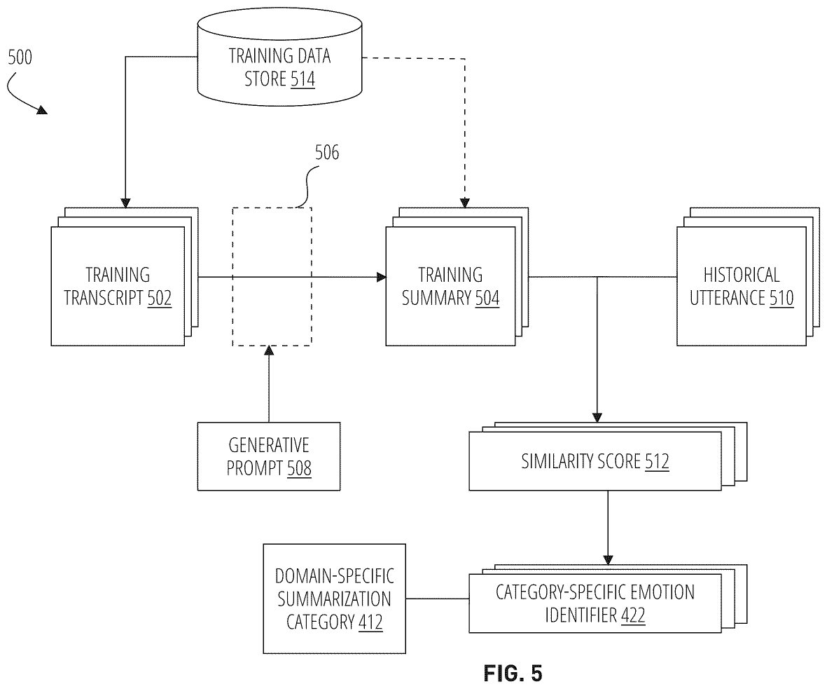

In some examples, the machine learning summarization model 420 may include a generative model configured to generate natural language text based on a generative prompt. For example, the generative model may include an LLM, such as a GPT model. The machine learning summarization model 420, for example, may include a same or different architecture as a training summarizer described with reference to FIG. 5. The machine learning summarization model 420 may be configured to generate a transcript summary 418 based on a generative prompt (e.g., a no shot prompt, few shot prompt, etc.). The generative prompt, for example, may include instructions to generate an abstractive and/or extractive summary of a transcript data object 402 based one or more summarization criteria. The summarization criteria, for example, may define the one or more targeted aspects of the transcript data object 402, a text length, a hallucination limit, and/or the like. In some examples, the generative prompt may include one or more summary examples for formatting the transcript summary 418. In some examples, the generative prompt may include one or more relevant utterances 414 from the transcript data object 402.

In some examples, the machine learning summarization model 420 may include an LLM that is finetuned using a domain-specific dataset. By way of example, the machine learning summarization model 420 may be finetuned over a training data store, as described herein with reference to FIG. 5. In this manner, the machine learning summarization model 420 may be utilized to generate one or more transcript summaries 418 tailored to a specific type of content, such as caller intent and agent resolution in a customer service domain, and/or the like. In some examples, a transcript summary 418 may be stored in the training data store to continuously augment the training data store with relevant training samples.

In some embodiments, the machine learning summarization model 420 receives one or more relevant utterances 414 from the transcript data object 402 and a generative prompt as an input, and based on the generative prompt, outputs the transcript summary 418 based on the one or more relevant utterances 414. The one or more relevant utterances 414, for example, may be identified using the domain-specific relevancy predictions 410, as described herein. In some examples, the transcript summary 418 may be an abstractive summary. In some examples, a machine learning summarization model 420 may be configured to output a specific quantity of tokens (e.g., words based on a text length criterion, etc.). For example, the machine learning summarization model 420 may output an abstractive summary with a maximum token length of 512 tokens. As described herein, utilizing the machine learning summarization model 420 to generate an abstractive summary based on the one or more relevant utterances 414 may provide one or more advantages when compared to conventional techniques. For example, generating a transcript summary 418 based on previously identified relevant utterances 414 may provide improved, more tailored, and effective summarizations at the expense of less processing resources when compared to generating a summary based on an entire transcript data object 402.

In some examples, one or more relevant utterances 414 with domain-specific relevancy predictions 410 that satisfy a respective relevancy threshold 416 may be input to the machine learning summarization model 420 for the creation of a transcript summary 418 based on the one or more relevant utterances 414. Additionally, or alternatively, the transcript summary 418 may be based on one or more utterances before and/or after the one or more relevant utterances 414 with domain-specific relevancy predictions 410. For example, a relevant utterance 414 may have a domain-specific relevancy prediction 410 that satisfies a relevancy threshold 416. The relevant utterance 414, in addition to one or more second utterances (n1), preceding the relevant utterance 414 and one or more third utterances (n2) subsequent to the relevant utterance 414 may be used to create the transcript summary 418 (e.g., an extractive summary). In such examples, the quantities of adjacent utterances (n1 and n2) may be preconfigured or based on respective relevancy thresholds 416 for the adjacent utterances.

In some examples, one or more filtering operations may be performed to remove or otherwise filter one or more words, terms, and/or phrases from the one or more utterance text segments 404. The one or more filtering operations, for example, may be performed on the one or more relevant utterances 414 selected for input to the machine learning summarization model 420. For example, prior to inputting the one or more utterances to the machine learning summarization model 420, the one or more relevant utterances 414 may be filtered to remove one or more one or more words, terms, and/or phrases including predefined filler words (e.g., “uh,” “um,” “actually,” and/or the like), stop words (e.g., prepositions, articles, conjunctions, pronouns, verbs, and/or the like), domain-specific words, and/or the like. Additionally, or alternatively, the one or more filtering operations may include removing various sections of a transcript data object 402 (e.g., a beginning section, a middle section, an ending section). In such examples, various sections may be defined or otherwise preconfigured based on a transcript length (e.g., a quantity of utterances in a transcript data object). For example, a transcript data object 402 may be divided into thirds. Accordingly, if a transcript data object 402 includes 999 utterances, a beginning section of the transcript data object 402 may be defined as including utterances 1 through 333, a middle section of the transcript data object 402 may be defined as including utterances 334 through 666, and an end section of the transcript data object 402 may be defined as including utterances 667 through 999.

In some examples, one or more sequence verification and/or reordering operations may be performed to verify or otherwise ensure that the one or more relevant utterances 414 selected for input to the machine learning summarization model 420 are correctly sequenced (e.g., correctly ordered, ordered chronologically, etc.). In some examples, the one or more sequence verification and/or reordering operations may be performed by checking an utterance identifier for each of the one or more utterance text segments 404 to confirm that an utterance text segment ordering is sequential. For example, a chronologically first utterance text segment of the transcript data object 402 may have an utterance identifier of “1,” a chronologically second utterance text segment of the transcript data object 402 may have an utterance identifier of “2,” and so forth. Additionally, or alternatively, each utterance text segment 404 may have a timestamp, which may be utilized to order or reorder utterance text segments 404 prior to input to the machine learning summarization model 420.

In some embodiments, the transcript summary 418 a text-based data object that describes or otherwise summarizes at least a portion of a transcript data object 402. In some examples, a transcript summary 418 may include a portion of utterance text segments 404 from a transcript data object 402 (e.g., an extractive summary, etc.). In such examples, the portion of utterance text segments 404 may include one or more text segments that convey an overarching theme of the transcript data object 402 or information relevant to one or more specific topics (e.g., an abstractive summary, etc.). For example, the transcript summary 418 may include one or more utterance text segments 404 that convey one or more caller intents, one or more agent resolutions, and/or the like. The transcript summary 418 may be an extractive summary or an abstractive summary. An extractive summary may include a direct recitation or listing of one or more utterance text segments 404 (e.g., the relevant utterances 414, etc.) from the transcript data object 402. An abstractive summary may include one or more text segments (e.g., new text segments) that are derived from one or more utterance text segments 404 (e.g., the relevant utterances 414, etc.) from the transcript data object 402. In some examples, the transcript summary 418 may be generated or otherwise output by a model, such as the machine learning summarization model 420, based on one or more relevant utterances 414 from the transcript data object 402.

In some examples, the transcript summary 418 output by the machine learning summarization model 420 may be contextualized based on the contextual data (e.g., emotion prediction vector 408, etc.) leveraged to filter the plurality of relevant utterances 414 from the transcript data object 402. For example, the transcript summary 418 may be contextualized by a transcript sentiment 430.

In some embodiments, the transcript sentiment 430 is generated for the transcript data object 402 based on the emotion prediction scores used for the summarization process. For example, the transcript sentiment 430 may be generated for the transcript data object 402 based on a concluding subset of the plurality of emotion prediction scores that correspond to one or more concluding utterances 424 from the transcript data object 402. In some examples, the transcript sentiment 430 may be assigned to the transcript summary 418 to generate a predictive output 432.

In some embodiments, the transcript sentiment 430 is a data entity that describes an overarching emotion or theme of the transcript data object 402 or a portion of the transcript data object 402. For example, the transcript sentiment 430 may indicate a sentiment or emotion associated with any portion of the transcript data object 402, such as an ending portion of a transcript data object 402 (e.g., for the last ten utterance text segments 404 of the transcript data object 402). In some examples, the transcript sentiment 430 may include one of one or more overall sentiment emotion identifiers. Each overall sentiment emotion identifier, for example, may include an emotion identifier from the plurality of emotion identifiers of an emotion ontology that is predesignated for representing an overall sentiment option for the transcript data object 402. By way of example, the overall sentiment emotion identifiers may include a negative emotion identifier (e.g., frowning emoji, etc.), a neutral emotion identifier (e.g., a neutral face emoji, etc.), a positive emotion identifier (e.g., smiling emoji, etc.), and/or the like. In some examples, the transcript sentiment 430 may be generated based on a concluding subset of emotion prediction scores corresponding to one or more concluding utterances 424 of the transcript data object 402.

In some embodiments, the concluding subset of emotion prediction scores is a plurality of emotion prediction scores for each concluding utterance of the transcript data object 402. In some examples, the concluding subset of emotion prediction scores may include a highest emotion prediction score from the emotion prediction vector 408 for each of the concluding utterances 424. In addition, or alternatively, the concluding subset of emotion prediction scores may include the emotion prediction vector 408 for each of the concluding utterances 424.

In some embodiments, a concluding utterance is a subset of utterance text segments 404 from the transcript data object 402 that is used to identify a transcript sentiment 430. The number of concluding utterances 424 may be configurable. In some examples, the concluding utterances 424 may include the last ten (e.g., last in temporal order) utterance text segments 404 from the transcript data object 402. In some examples, a concluding subset of emotion prediction scores may include ten of the highest emotion prediction scores respectively corresponding to the last ten utterance text segments from the transcript data object 402. In addition, or alternatively, the concluding subset of emotion prediction scores may include ten emotion prediction vectors respectively corresponding to the last ten utterance text segments from the transcript data object 402. In such a case, the transcript sentiment 430 may be determined based on one or more sentiment bucket scores 428 determined from the emotion prediction vectors 408.

In some embodiments, a plurality of sentiment bucket scores 428 is generated based on the concluding subset of the plurality of emotion prediction scores from the concluding utterances 424. A sentiment bucket score 428, for example, may include an aggregation of a bucket subset of the concluding subset of the plurality of emotion prediction scores that correspond to one or more bucket-specific emotion identifiers 426 of the plurality of emotion identifiers. In some examples, each of the plurality of sentiment bucket scores 428 corresponds to a predefined sentiment option of a plurality of predefined sentiment options. The transcript sentiment 430 may be identifier from the plurality of predefined sentiment options based on a comparison between the plurality of sentiment bucket scores 428.

In some embodiments, a sentiment bucket score 428 is a data value that describes an aggregate value of emotion prediction scores associated with a particular sentiment bucket. For example, a first sentiment bucket score (e.g., a positive sentiment bucket score) may be determined by aggregating (e.g., adding, etc.) emotion prediction scores for a first plurality of emotion identifiers in a first sentiment bucket (e.g., a positive sentiment bucket). A second sentiment bucket score (e.g., a negative sentiment bucket score) may be determined by aggregating (e.g., adding, etc.) emotion prediction scores for a second plurality of emotion identifiers in a second sentiment bucket (e.g., a negative sentiment bucket). A third sentiment bucket score (e.g., a neutral sentiment bucket score) may be determined by aggregating (e.g., adding, etc.) emotion prediction scores for a third plurality of emotion identifiers in a third sentiment bucket (e.g., a neutral sentiment bucket). As described herein, the emotion prediction scores utilized to determine a sentiment bucket score 428 may be taken from a quantity of concluding utterances 424 of the transcript data object 402.

In some embodiments, the bucket subset is a subset of emotion identifiers that are associated with a particular sentiment bucket. For example, a first bucket subset of emotion identifiers may be selected for a first sentiment bucket (e.g., a positive sentiment bucket). The first bucket subset may include emotion identifiers indicative of one or more positive emotions. A second bucket subset of emotion identifiers may be selected for a second sentiment bucket (e.g., a negative sentiment bucket). The second bucket subset may include emotion identifiers indicative of one or more negative emotions. A third bucket subset of emotion identifiers may be selected for a third sentiment bucket (e.g., a neutral sentiment bucket). The third bucket subset may include emotion identifiers indicative of one or more neutral emotions.

In some embodiments, a bucket-specific emotion identifier is an emotion identifier that is categorized or otherwise grouped in a bucket subset. For example, a laughing emoji may be an example of a bucket-specific emotion identifier for a positive sentiment bucket, an angry emoji may be an example of a bucket-specific emotion identifier for a negative sentiment bucket, etc. In some examples, each emotion identifier of an emotion ontology may be categorized as a bucket-specific emotion identifier of a bucket subset for one of the overall sentiment emotion identifiers designated for a prediction domain.

In this manner, sentiment analysis may be adapted and integrated with text summarization techniques to generate a predictive output 432 reflective of a transcript summary 418 and transcript sentiment for a transcript data object 402. In some examples, the sentiment analysis techniques of the present disclosure may be tailored to a particular domain to enable the streamlined and efficient summarization of text. For example, the sentiment analysis techniques may adapt traditional sentiment analysis outputs to a summarization process for text from a particular domain. An example of such techniques is described further with reference to FIG. 5.

FIG. 5 is a dataflow diagram 500 showing example data structures and modules for adapting sentiment analysis for text summarization in accordance with some embodiments discussed herein. As depicted, a set of category-specific emotion identifier 422 may be identified from a plurality of emotion identifiers based on a correlation between the emotion identifiers and training summaries 504 for a plurality of training transcript 502. By doing so, the category-specific emotion identifier 422 may be leveraged to identify relevant utterances during a summarization process as described with reference to FIG. 4. In some examples, the category-specific emotion identifier 422 may be automatically generated using training summaries 504 output by a training summarizer 506 to ensure that a summarization process achieves the accuracy of the training summarizer 506 without expending the processing resources required by the training summarizer 506. In this way, a training summarizer 506 may be used in an offline process and then subsequently removed from a summarization pipeline during online operations. Ultimately, this allows for a more efficient summarization process that leverages less computing resources to achieve the same or better outputs of traditional techniques.

In some embodiments, the one or more category-specific emotion identifier 422 are identified from a plurality of training transcripts 502 based on a predictive correlation to the domain-specific summarization category 412. In some examples, each set of category-specific emotion identifiers 422 may include a predetermined number (e.g., five, ten, one hundred, etc.) of emotion identifiers from an emotion ontology based on the predictive correlation between a plurality of emotion identifiers to a domain-specific summarization category 412 (e.g., the highest ranked emotion identifiers, etc.). In addition, or alternatively, set of category-specific emotion identifiers 422 may include a dynamic number of emotion identifiers based on a predictive correlation between a plurality of emotion identifiers to the domain-specific summarization category 412 (e.g., all emotion identifiers with a predictive correlation that achieves a threshold, etc.).

As an example, using a 64-emotion identifier ontology in a dual (e.g., two) domain-specific summarization category domain, such as a customer service domain with dueling aspects of interest (e.g., caller intent and agent resolution), one or more emotion identifiers from the plurality of emotion identifiers may be extracted to create (i) a first subset of emotion identifiers associated with a first category (e.g., a caller intent category, etc.) and (ii) a second subset of emotion identifiers associated with a second category (e.g., an agent resolution category, etc.). In some examples, the plurality of emotion identifiers and/or historical data associated therewith may be processed at a predetermined frequency to update the first and second subsets based on historical correlations between the plurality of emotion identifiers and a target aspect of a transcript. At a first time, for example, a first subset of emotion identifiers may include an anger emoji, frustration emoji, confusion emoji, and/or the like that may have a predictive correlation to a caller intent category. In addition, or alternatively, a second subset of emotion identifiers may include a thumbs up emoji, a peace sign emoji, a winking emoji, and/or the like that may have a predictive correlation to an agent resolution category.

In some examples, the predictive correlation may be based on a similarity score 512 between (a) a historical utterance 510 of a training transcript 502 that corresponds to the domain-specific summarization category 412 and (b) a training summary 504 of the training transcript 502. In some examples, the historical utterance 510 is associated with a historical emotion prediction vector. For example, category-specific emotion identifiers 422 may be identified and/or iteratively refined for each domain-specific summarization category 412 of a prediction domain based on a correlation between the plurality of emotion identifiers and a plurality of similarity scores 512 between a plurality of historical utterances 510 and training summaries 504.

In some embodiments, the similarity score 512 refers to a data value that describes a degree of similarity between a pair of text segments. For example, a similarity score 512 may describe a syntactic similarity between a first and second text segment. In some examples, a first text segment may include a synthetic and/or user training summary 504. A second text segment may include a historical utterance 510 from a training transcript 502 corresponding to the training summary 504. By way of example, a similarity score 512 may include a cosine similarity between the first and second text segments.

In some embodiments, a historical utterance 510 is a data entity that describes an utterance text segment 404 from a training transcript 502. For example, a historical utterance 510 may include a historical text segment from a training transcript 502 that is stored in a training data store 514. A training data store 514, for example, may include a plurality of training transcript 502 the respectively correspond to a plurality of historical and/or synthetic call transcripts. Each training transcript 502 may include a plurality of historical utterances 510 that may be preprocessed to assign one or more training indicators, such as a historical emotion prediction vector, an emotion identifier, etc.

In some embodiments, a historical emotion prediction vector is a set of one or more values that respectively indicate one or more emotion probabilities for a historical utterance 510. In some examples, the historical emotion prediction vector may be generated by an emotion classification model, as described herein. The historical emotion prediction vector may be a data structure that describes a plurality of emotion prediction scores for an utterance text segment, such as a historical utterance 510 from a training transcript 502. For example, a historical emotion prediction vector may include a plurality of one or more data values (e.g., real numbers, percentages, ratio, etc.) that respectively correspond to a plurality of defined emotions of an emotion ontology. Each data value, for instance, may include an indicated emotion identifier probability or likelihood reflective of a correspondence between a particular emotion and a historical utterance 510. In some examples, a historical emotion prediction vector may include a dimension for each of a plurality of defined emotions of the emotion ontology. For example, a historical emotion prediction vector may include a 64-dimensional vector that defines 64 emotion prediction scores respectively corresponding to 64 defined emotion identifiers of the emotion ontology.

In some embodiments, the training summary 504 is generated using a training summarizer 506. For example, a training summary 504 may be generated using the training summarizer 506 to automatically identify, refine, and/or monitor the sets of category-specific emotion identifiers 422 for each domain-specific summarization category 412.

In some embodiments, a training summary 504 is a ground truth summary of a training transcript 502. The training summary 504 may include a synthetic and/or user summary for the training transcript 502. A user summary, for example, may include a manual summary of the historical transcript data object. A synthetic summary may include a model-based summary, such as an abstractive summary generated by the training summarizer 506. In some examples, a training summary 504 may be generated based on one or more targeted aspects of a transcript, such as caller intent and/or agent resolution aspects in a customer service domain.

In some embodiments, the training summarizer 506 is a data entity that describes parameters, hyper-parameters, and/or defined operations of a rules-based and/or machine learning model (e.g., a model including at least one of one or more rule-based layers, one or more layers that depend on trained parameters, coefficients, and/or the like). The training summarizer 506 may include a machine learning model trained and/or configured to generate a training summary 504 from a training transcript 502, as described herein. The training summarizer 506 may include one or more of any type of machine learning model including one or more supervised, unsupervised, semi-supervised, and/or reinforcement learning models. In some embodiments, the training summarizer 506 may include multiple models configured to perform one or more different stages of a summarization process.

In some examples, the training summarizer 506 may include a generative model configured to generate natural language text based on a generative prompt. For example, the generative model may include an LLM, such as a GPT model. In some examples, the generative model may include a GPT-3.5 model and/or any other machine learning model with generative capabilities. The generative model may be configured to generate a training summary 504 based on a generative prompt 508 (e.g., a no shot prompt, a few shot prompt, etc.). The generative prompt 508, for example, may include instructions to generate an abstractive and/or extractive summary of a training transcript 502 based one or more summarization criteria. The summarization criteria, for example, may define the one or more targeted aspects of the transcript, a text length, a hallucination limit, and/or the like. In some examples, the generative prompt may include one or more summary examples for formatting the training summary 504.

In some embodiments, the training summarizer 506 may receive a training transcript 502 and generative prompt 508 as an input and, in response to the generative prompt 508, output a training summary 504 for the training transcript 502. In some examples, the training transcript 502 may be preprocessed to remove PII before providing the training transcript 502 to the training summarizer 506.

In some examples, the training summarizer 506 may include an LLM that is finetuned using a domain-specific dataset. By way of example, the training summarizer 506 may be finetuned over a training data store 514, as described herein. In this manner, the training summarizer 506 may be utilized to generate one or more training summaries 504 tailored to a specific type of content, such as caller intent and agent resolution in a customer service domain. In some examples, the one or more training summaries 504 may be stored in the training data store 514 to continuously augment the training data store 514 with relevant training samples.

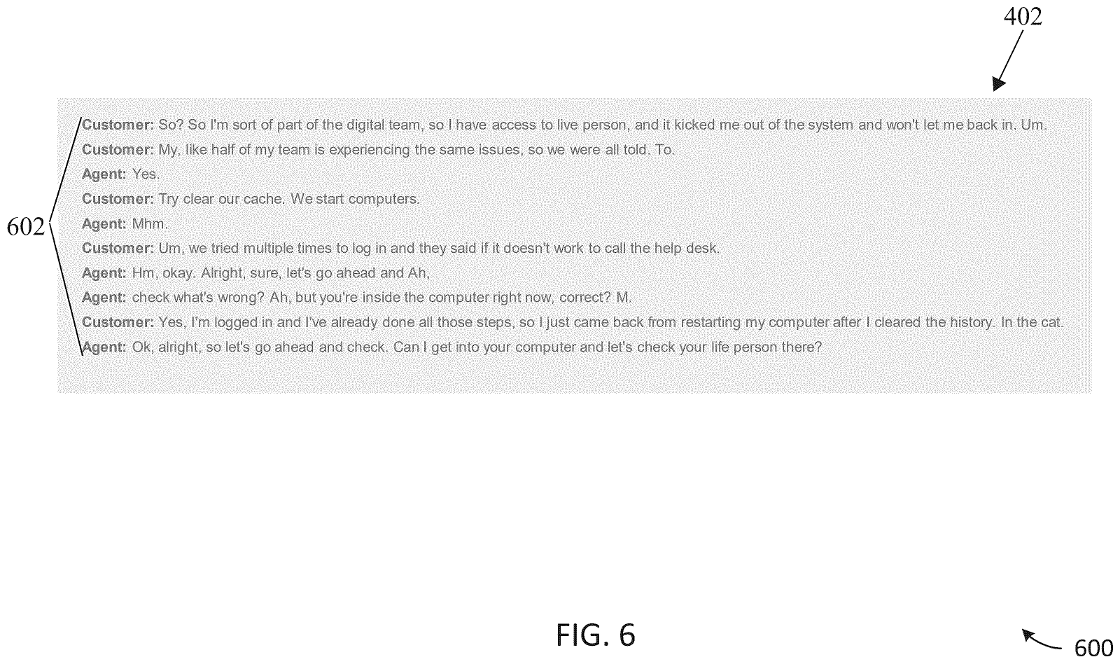

FIG. 6 is an operational example 600 of a transcript data object in accordance with some embodiments discussed herein. As shown, the transcript data object 402 may include one or more utterances 602 corresponding to one or more participants to a dialog. In the customer service example illustrated by the operational example 600, a first participant may include a customer and a second participant may include an agent.

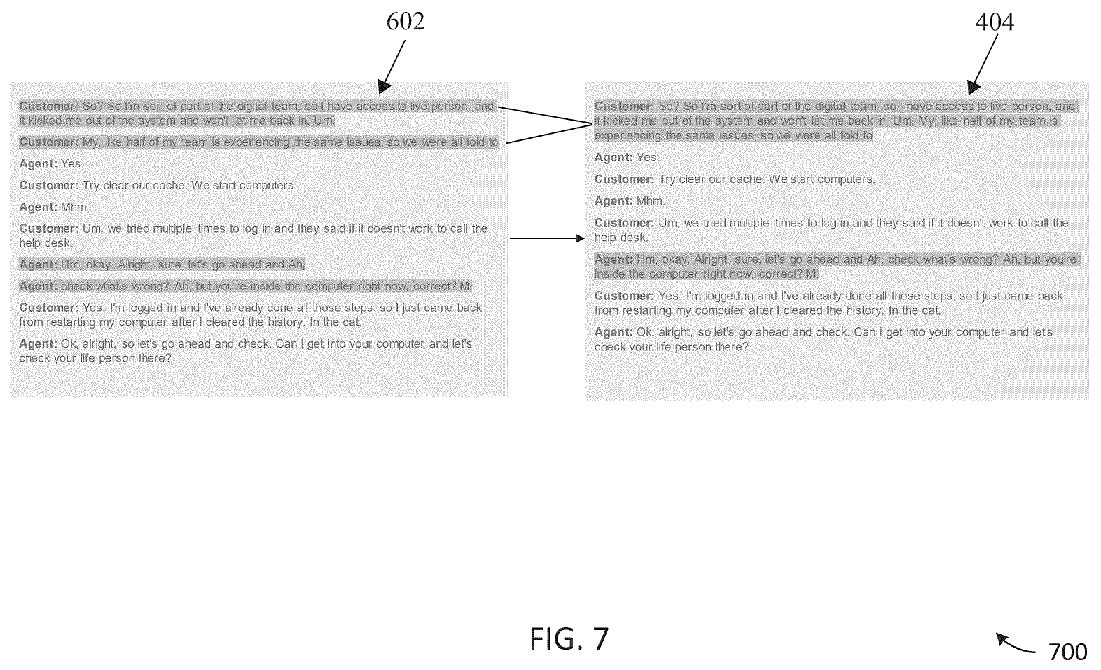

FIG. 7 is an operational example 700 of a preprocessing stage of the multi-stage, sentiment-based text interpretation process in accordance with some embodiments discussed herein. As depicted, the preprocessing stage of the multi-stage, sentiment-based text interpretation process may include a preprocessing operation in which one or more utterance text segments 404 may be generated by combining two or more adjacent utterances 602 from a transcript data object 402 in accordance with one or more joining criteria, such as a matching participant, etc.

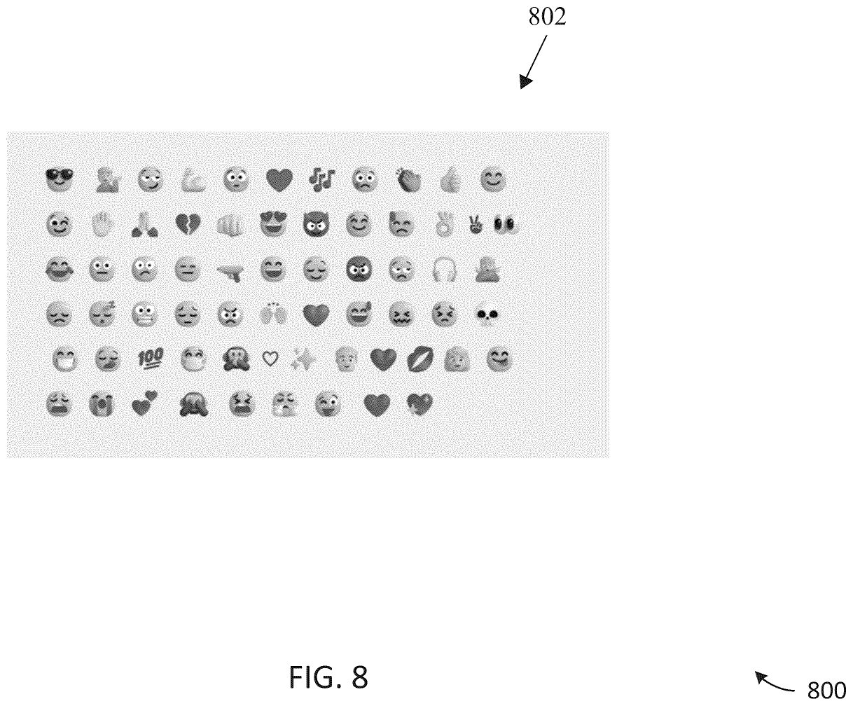

FIG. 8 is an operational example 800 of an emotion ontology in accordance with some embodiments discussed herein. As depicted, an emotion ontology may include a plurality of emotion identifiers 802. Each emotion identifier of the set of emotion identifiers 802 may correspond to or otherwise indicate an emotion. By way of example, the plurality of emotion identifiers 802 may include a plurality of emojis, each reflective of an emotion.

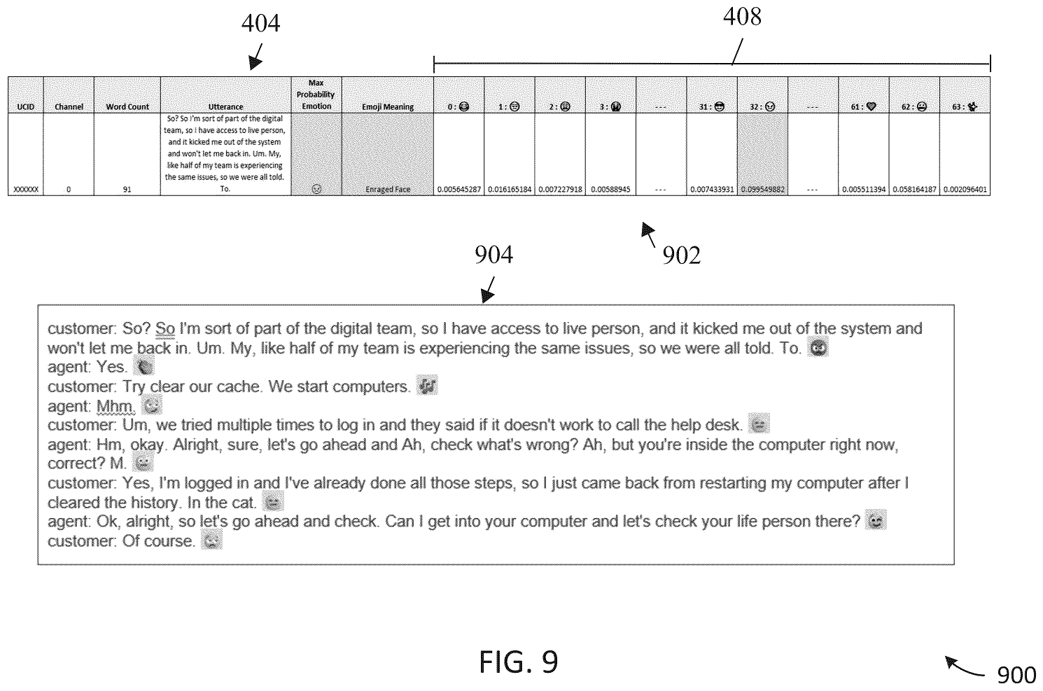

FIG. 9 is an operational example 900 of a sentiment analysis stage of the multi-stage, sentiment-based text interpretation process in accordance with some embodiments discussed herein. As shown, the sentiment analysis stage may include a vector prediction stage in which an emotion prediction vector 408 is generated for each utterance text segment 404 of a transcript data object. Each emotion prediction vector 408 may include a plurality prediction scores 902 for a plurality of emotion identifiers of an emotion ontology. In some examples, a highest scoring emotion identifier may be assigned to each utterance text segment 404 to generate an augmented transcript data object 904.

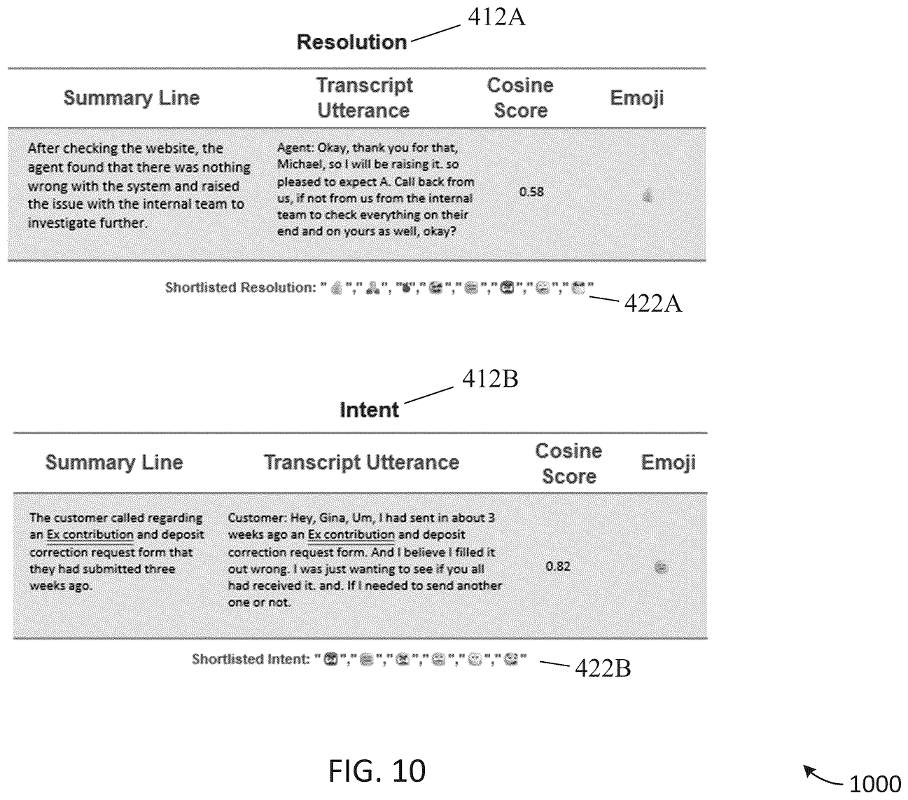

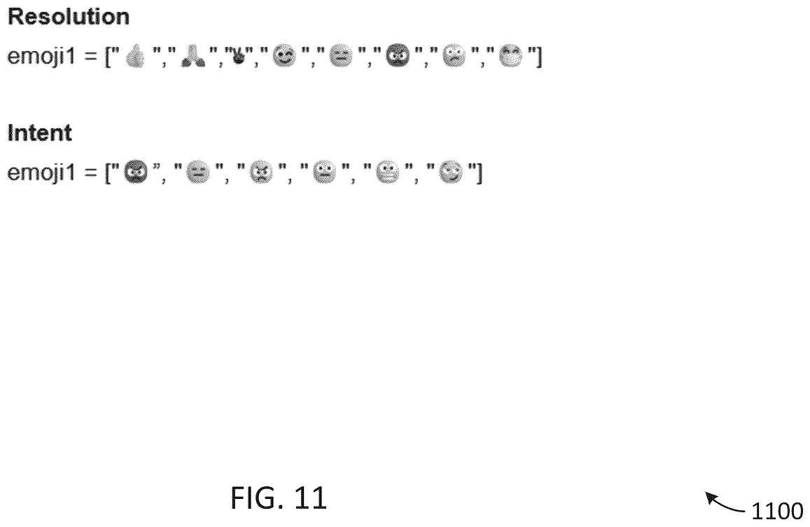

FIG. 10 is an operational example 1000 of a sentiment analysis adapting stage of the multi-stage, sentiment-based text interpretation process in accordance with some embodiments discussed herein. As depicted, during the sentiment analysis adapting stage a set of category-specific emotion identifiers 422A-B may be respectively identified for each of a plurality of domain-specific summarization categories 412A-B. For example, in a customer service domain, a first domain-specific summarization category 412A may include an agent resolution category that is assigned a first set of category-specific emotion identifiers 422A and a second domain-specific summarization category 412B may include a caller intent category that is assigned a second set of category-specific emotion identifiers 422B. FIG. 11 is an operational example 1100 of sets of category-specific emotion identifiers in accordance with some embodiments discussed herein.

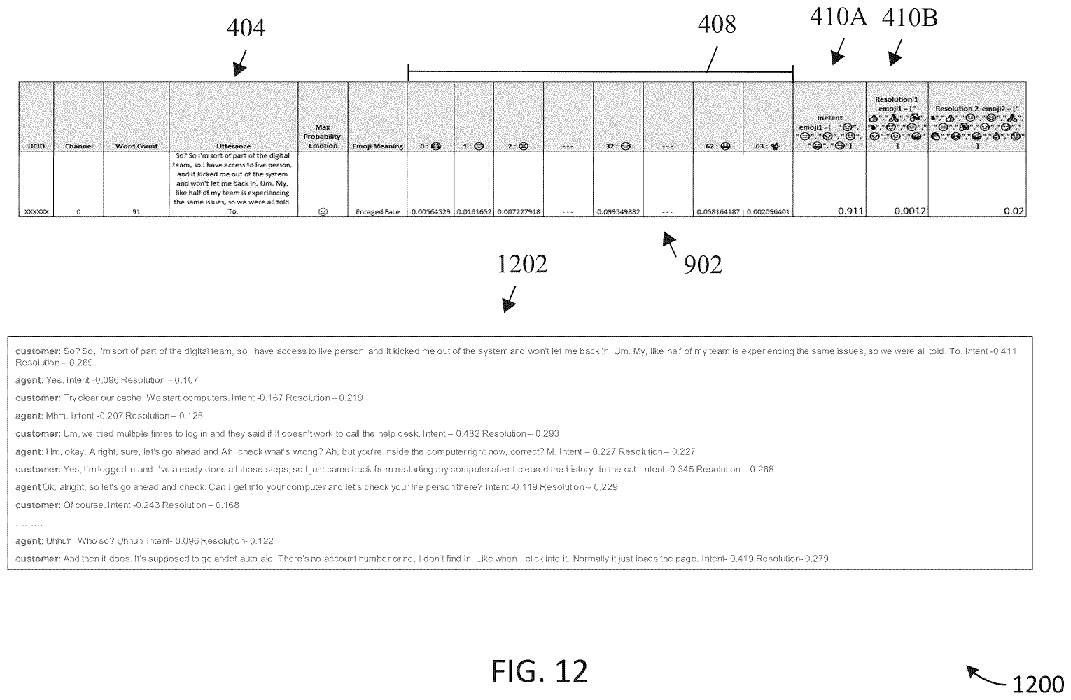

FIG. 12 is an operational example 1200 of a domain-specific relevancy prediction stage of the multi-stage, sentiment-based text interpretation process in accordance with some embodiments discussed herein. As depicted, the domain-specific relevancy prediction stage may include aggregating two or more emotion prediction scores 902 from an emotion prediction vector 408 of each utterance text segment 404 to generate domain-specific relevancy predictions 410A-B for each of a plurality of plurality of domain-specific summarization categories. In some examples, the domain-specific relevancy predictions 410A-B may be assigned to each utterance text segment 404 to generate an augmented transcript data object 1202.

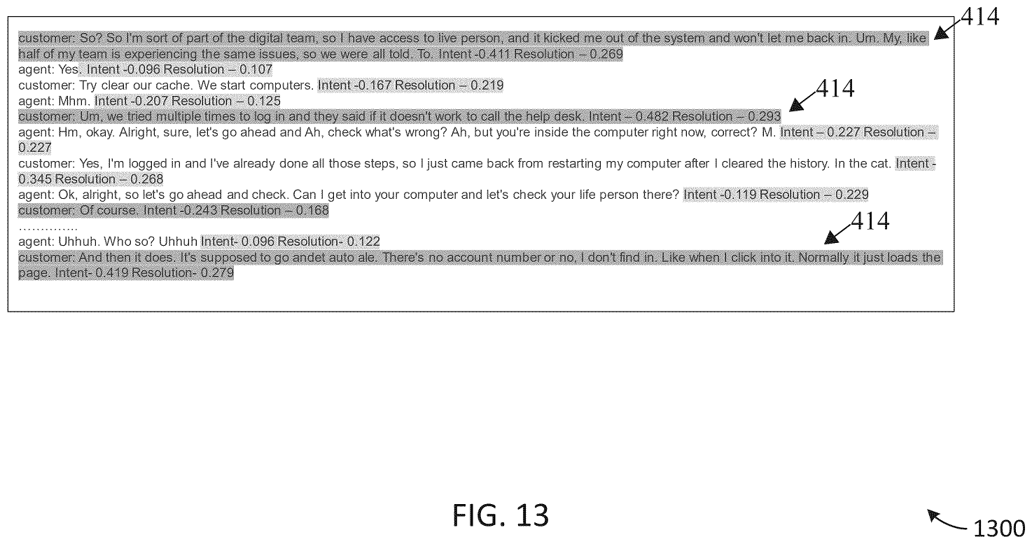

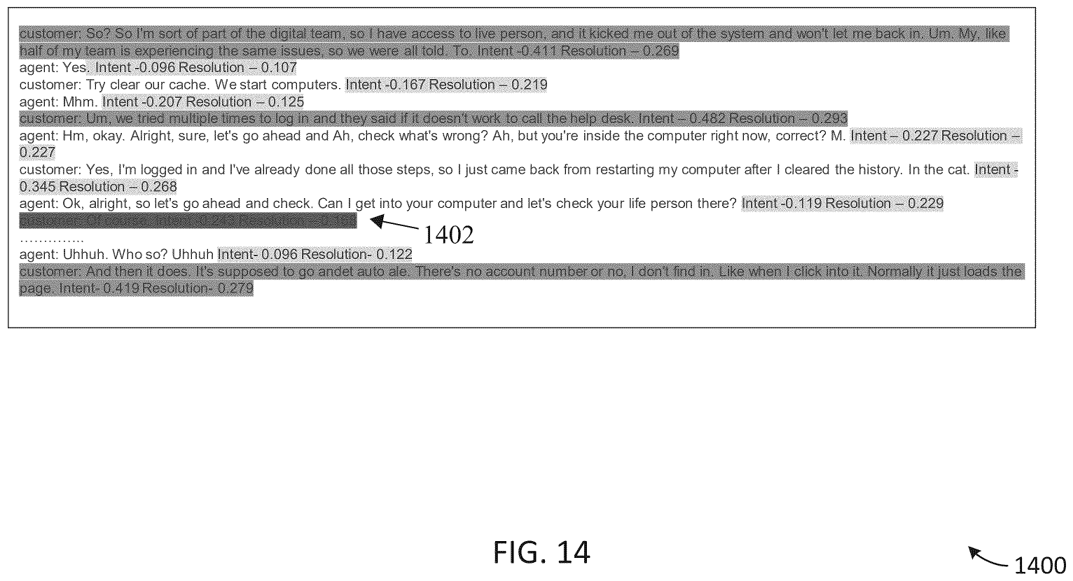

FIG. 13 is an operational example 1300 of relevant utterances 414 from a transcript data object in accordance with some embodiments discussed herein. FIG. 14 is an operational example 1400 of irrelevant utterances 1402 in accordance with some embodiments discussed herein.

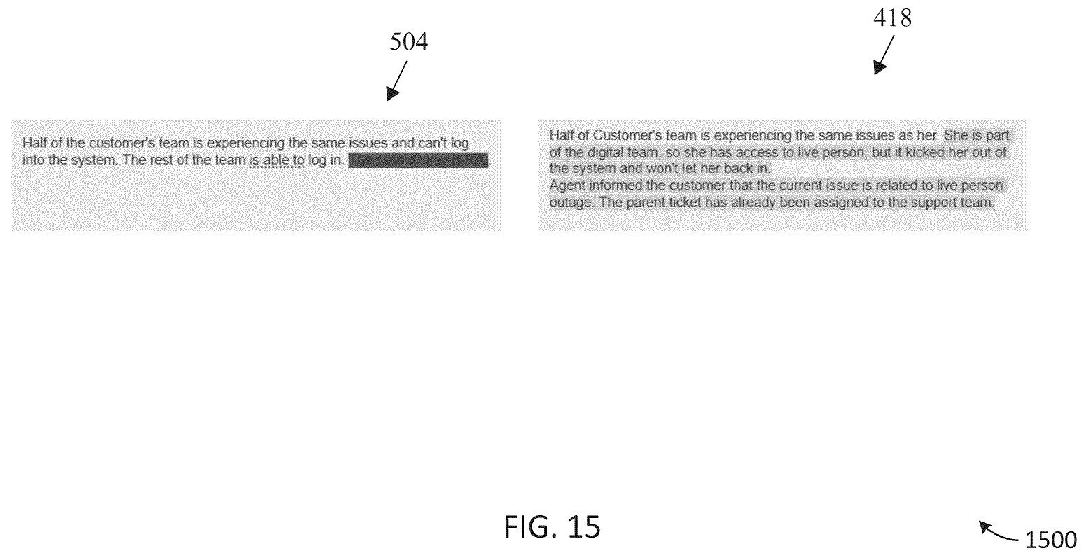

FIG. 15 is an operational example 1500 of transcript summaries in accordance with some embodiments discussed herein. A first transcript summary may include a training summary 504 that may be generated using a traditional summarization model, such as the training summarizer as described herein. A second transcript summary may include a transcript summary 418 that may be generated using the multi-stage, sentiment-based text interpretation process of the present disclosure. As shown, the transcript summary 418 may include additional details that capture targeted aspects of a transcript data object that may be missed using traditional techniques.

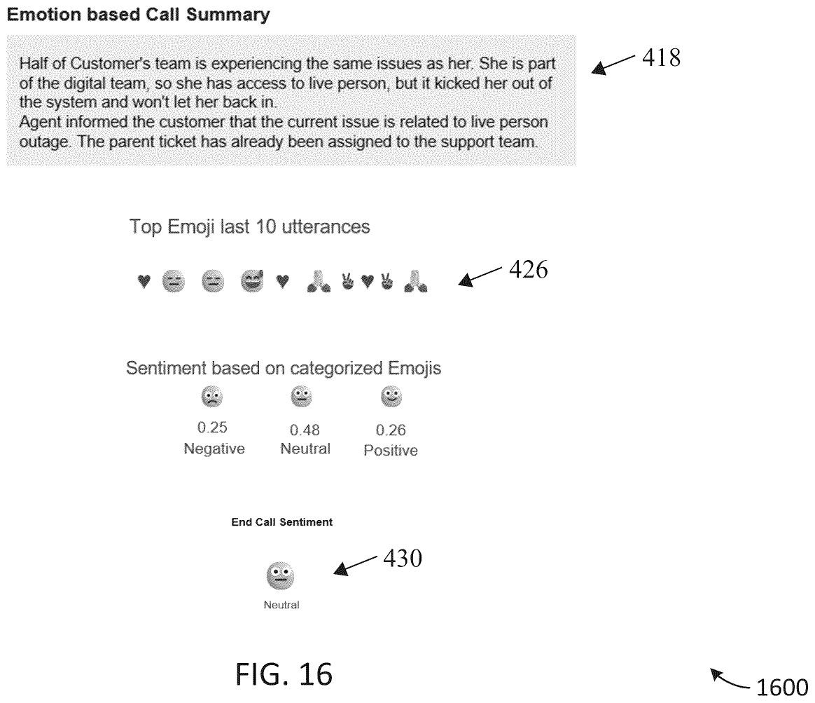

FIG. 16 is an operational example 1600 of a sentiment assignment stage of the multi-stage, sentiment-based text interpretation process in accordance with some embodiments discussed herein. As depicted, a transcript sentiment 430 may be assigned to a transcript summary 418 based on bucket-specific emotion identifiers 426 corresponding to the concluding utterances of a transcript data object.

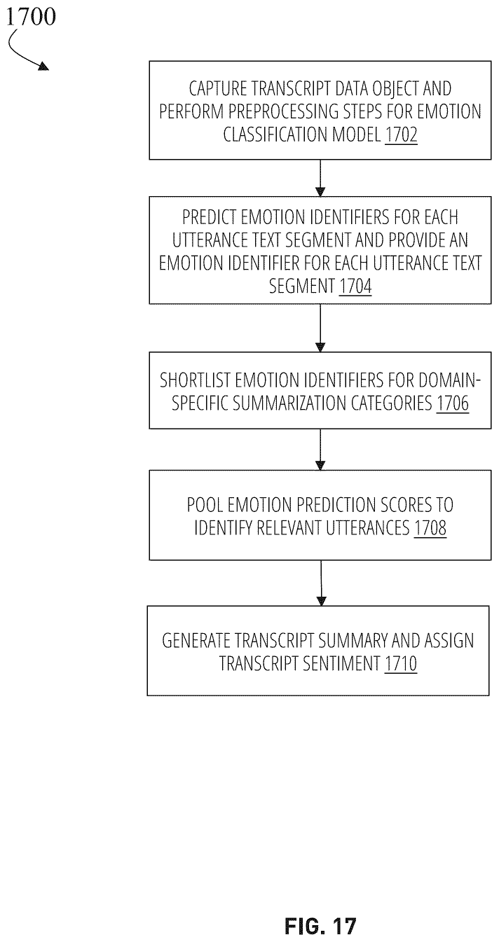

FIG. 17 is a flowchart diagram of an example multi-stage, sentiment-based text interpretation process 1700 in accordance with some embodiments discussed herein. The flowchart depicts a process 1700 for integrating sentiment analysis with machine learning text summarization techniques. The process 1700 may be implemented by one or more computing devices, entities, and/or systems described herein. For example, via the various steps/operations of the process 1700, the computing system 101 may leverage improved machine learning techniques to integrate two traditionally independent machine learning tasks, sentiment analysis and text summarization. By doing so, the process 1700 facilitates an improved text summarization pipeline that is directly tailored to addressing technical challenges of traditional text summarization technologies and may be leveraged to improve the quality of computer text comprehension at a fraction of the computing resources traditionally required.

FIG. 17 illustrates an example process 1700 for explanatory purposes. Although the example process 1700 depicts a particular sequence of steps/operations, the sequence may be altered without departing from the scope of the present disclosure. For example, some of the steps/operations depicted may be performed in parallel or in a different sequence that does not materially impact the function of the process 1700. In other examples, different components of an example device or system that implements the process 1700 may perform functions at substantially the same time or in a specific sequence.

In some embodiments, the process 1700 includes, at step/operation 1702, capturing a transcript data object and performing preprocessing steps for an emotion classification model. For example, the computing system 101 may receive the transcript data object, identify an utterance text segment from the transcript data object, and provide the utterance text segment as an input to the emotion classification model to receive an emotion prediction vector at step/operation 1704. In some examples, the computing system 101 may remove one or more utterance text segments from the transcript data object based on one or more of (i) a location of the one or more utterance text segments within the transcript data object or (ii) a content-based categorization of the one or more utterance text segments.

In some embodiments, the process 1700 includes, at step/operation 1704, predicting emotion identifiers for each utterance text segment and providing an emotion identifier for each utterance text segment. For example, the computing system 101 may receive, from an emotion classification model, an emotion prediction vector for an utterance text segment from a transcript data object. The emotion prediction vector may include a plurality of emotion prediction scores respectively corresponding to a plurality of emotion identifiers.

In some embodiments, the process 1700 includes, at step/operation 1706, shortlisting emotion identifiers for domain-specific summarization categories. For example, the computing system 101 may identify one or more category-specific emotion identifiers for each of the domain-specific summarization categories. The one or more category-specific emotion identifiers may be identified from a plurality of training transcripts based on a predictive correlation to each domain-specific summarization category. The predictive correlation may be based on a similarity score between (a) a historical utterance of a training transcript that corresponds to the domain-specific summarization category and (b) a training summary of the training transcript. In some examples, the training summary may be generated using a large language model. In addition, or alternatively, the historical utterance may be associated with a historical emotion prediction vector.

In some embodiments, the process 1700 includes, at step/operation 1708, pooling emotion prediction scores to identify relevant utterances. For example, the computing system 101 may generate a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category. In some examples, the domain-specific relevancy prediction includes an aggregation of the category-relevant subset of the plurality of emotion prediction scores for the domain-specific summarization category. In some examples, the domain-specific relevancy prediction may include a probability that the utterance text segment is associated with (i) an expression of intent, (ii) an expression of a resolution, or (iii) an expression of contextual information.

The computing system 101 may identify the utterance text segment as a relevant utterance from the transcript data object based on a comparison between the domain-specific relevancy prediction and a relevancy threshold.

In some embodiments, the process 1700 includes, at step/operation 1710, generating a transcript summary and assigning a transcript sentiment to the transcript summary. For example, the computing system 101 may initiate a performance of a machine learning summarization operation based on the utterance text segment. Initiating the machine learning summarization operation may include providing the relevant utterance as an input to a machine learning summarization model to receive a transcript summary for the transcript data object.

In some examples, the computing system 101 may generate a transcript sentiment for the transcript data object based on a concluding subset of the plurality of emotion prediction scores that correspond to one or more concluding utterances from the transcript data object. The computing system 101 may generate a plurality of sentiment bucket scores based on the concluding subset of the plurality of emotion prediction scores. For instance, a sentiment bucket score may include an aggregation of a bucket subset of the concluding subset of the plurality of emotion prediction scores that correspond to one or more bucket-specific emotion identifiers of the plurality of emotion identifiers and each of the plurality of sentiment bucket scores may correspond to a predefined sentiment option of a plurality of predefined sentiment options. The computing system 101 may identify the transcript sentiment from the plurality of predefined sentiment options based on a comparison between the plurality of sentiment bucket scores. The computing system 101 may assign the transcript sentiment to the transcript summary to generate a predictive output.

Some techniques of the present disclosure enable the generation of actionable outputs that may be performed to initiate one or more real world actions to achieve real-world effects. The computer comprehension techniques of the present disclosure may be used, applied, and/or otherwise leveraged to enable the comprehension of natural language text. The comprehension of natural language text may trigger the performance of various computing tasks that improve the performance of a computing system (e.g., a computer itself, etc.) with respect to various actions performed by the computing system. Example actions may include the display, transmission, notification, and/or the like of data reflective of the comprehension of natural language text, such as the transcript summary and/or transcript sentiment as described herein. Moreover, the actions may include physical actions, such as a mailing of a physical letter, the provision of a control instruction to reboot a computer, control a robotic device to perform a debugging routine, and/or the like, that may be triggered in response to a transcript summary.

In some examples, the computing tasks may include actions that may be based on a prediction domain. A prediction domain may include any environment in which computing systems may be applied to generate predictive insights and initiate the performance of computing tasks responsive to the predictive insights. These actions may cause real-world changes, for example, by controlling a hardware component, providing alerts, interactive actions, and/or the like. For instance, actions may include the initiation of automated instructions across and between devices, automated notifications, automated maintenance operations, automated precautionary actions, automated security actions, automated data processing actions, and/or the like.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors and from an emotion classification model, an emotion prediction vector for an utterance text segment from a transcript data object, the emotion prediction vector comprising a plurality of emotion prediction scores respectively corresponding to a plurality of emotion identifiers; generating, by the one or more processors, a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category; identifying, by the one or more processors, the utterance text segment as a relevant utterance from the transcript data object based on a comparison between the domain-specific relevancy prediction and a relevancy threshold; and initiating, by the one or more processors, a performance of a machine learning summarization operation based on the utterance text segment.

Example 2. The computer-implemented method of example 1, wherein initiating the machine learning summarization operation comprises providing the relevant utterance as an input to a machine learning summarization model to receive a transcript summary for the transcript data object.

Example 3. The computer-implemented method of example 2, further comprising generating a transcript sentiment for the transcript data object based on a concluding subset of the plurality of emotion prediction scores that correspond to one or more concluding utterances from the transcript data object; and assigning the transcript sentiment to the transcript summary.

Example 4. The computer-implemented method of example 3, wherein generating the transcript sentiment comprises generating a plurality of sentiment bucket scores based on the concluding subset of the plurality of emotion prediction scores, wherein (i) a sentiment bucket score comprises an aggregation of a bucket subset of the concluding subset of the plurality of emotion prediction scores that correspond to one or more bucket-specific emotion identifiers of the plurality of emotion identifiers; and (ii) each of the plurality of sentiment bucket scores corresponds to a predefined sentiment option of a plurality of predefined sentiment options; and identifying the transcript sentiment from the plurality of predefined sentiment options based on a comparison between the plurality of sentiment bucket scores.

Example 5. The computer-implemented method of any of the preceding examples, further comprising receiving the transcript data object; identifying the utterance text segment from the transcript data object; and providing the utterance text segment as an input to the emotion classification model to receive the emotion prediction vector.

Example 6. The computer-implemented method of any of the preceding examples, wherein (i) the one or more category-specific emotion identifiers are identified from a plurality of training transcripts based on a predictive correlation to the domain-specific summarization category; and (ii) the predictive correlation is based on a similarity score between (a) a historical utterance of a training transcript that corresponds to the domain-specific summarization category and (b) a training summary of the training transcript.

Example 7. The computer-implemented method of example 6, wherein the training summary is generated using a large language model.

Example 8. The computer-implemented method of any of examples 6 or 7, wherein the historical utterance is associated with a historical emotion prediction vector.

Example 9. The computer-implemented method of any of the preceding examples, wherein the domain-specific relevancy prediction includes a probability that the utterance text segment is associated with (i) an expression of intent, (ii) an expression of a resolution, or (iii) an expression of contextual information.

Example 10. The computer-implemented method of any of the preceding examples, further comprising removing one or more utterance text segments from the transcript data object based on one or more of: (i) a location of the one or more utterance text segments within the transcript data object or (ii) a content-based categorization of the one or more utterance text segments.

Example 11. The computer-implemented method of any of the preceding examples, wherein the domain-specific relevancy prediction comprises an aggregation of the category-relevant subset of the plurality of emotion prediction scores.

Example 12. A computing system comprising memory and one or more processors communicatively coupled to the memory, the one or more processors configured to receive, from an emotion classification model, an emotion prediction vector for an utterance text segment from a transcript data object, the emotion prediction vector comprising a plurality of emotion prediction scores respectively corresponding to a plurality of emotion identifiers; generate a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category; identify the utterance text segment as a relevant utterance from the transcript data object based on a comparison between the domain-specific relevancy prediction and a relevancy threshold; and initiate a performance of a machine learning summarization operation based on the utterance text segment.

Example 13. The computing system of example 12, wherein initiating the machine learning summarization operation comprises providing the relevant utterance as an input to a machine learning summarization model to receive a transcript summary for the transcript data object.

Example 14. The computing system of example 13, wherein the one or more processors are further configured to generate a transcript sentiment for the transcript data object based on a concluding subset of the plurality of emotion prediction scores that correspond to one or more concluding utterances from the transcript data object; and assign the transcript sentiment to the transcript summary.

Example 15. The computing system of example 14, wherein generating the transcript sentiment comprises generating a plurality of sentiment bucket scores based on the concluding subset of the plurality of emotion prediction scores, wherein (i) a sentiment bucket score comprises an aggregation of a bucket subset of the concluding subset of the plurality of emotion prediction scores that correspond to one or more bucket-specific emotion identifiers of the plurality of emotion identifiers; and (ii) each of the plurality of sentiment bucket scores corresponds to a predefined sentiment option of a plurality of predefined sentiment options; and identifying the transcript sentiment from the plurality of predefined sentiment options based on a comparison between the plurality of sentiment bucket scores.

Example 16. The computing system of any of examples 12 through 15, wherein the one or more processors are further configured to receive the transcript data object; identify the utterance text segment from the transcript data object; and provide the utterance text segment as an input to the emotion classification model to receive the emotion prediction vector.

Example 17. The computing system of any of examples 12 through 16, wherein (i) the one or more category-specific emotion identifiers are identified from a plurality of training transcripts based on a predictive correlation to the domain-specific summarization category; and (ii) the predictive correlation is based on a similarity score between (a) a historical utterance of a training transcript that corresponds to the domain-specific summarization category and (b) a training summary of the training transcript.

Example 18. One or more non-transitory computer-readable storage media including instructions that, when executed by one or more processors, cause the one or more processors to receive, from an emotion classification model, an emotion prediction vector for an utterance text segment from a transcript data object, the emotion prediction vector comprising a plurality of emotion prediction scores respectively corresponding to a plurality of emotion identifiers; generate a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category; identify the utterance text segment as a relevant utterance from the transcript data object based on a comparison between the domain-specific relevancy prediction and a relevancy threshold; and initiate a performance of a machine learning summarization operation based on the utterance text segment.

Example 19. The one or more non-transitory computer-readable storage media of example 18, wherein the instructions further cause the one or more processors to remove one or more utterance text segments from the transcript data object based on one or more of: (i) a location of the one or more utterance text segments within the transcript data object or (ii) a content-based categorization of the one or more utterance text segments.

Example 20. The one or more non-transitory computer-readable storage media of examples 18 or 19, wherein the domain-specific relevancy prediction comprises an aggregation of the category-relevant subset of the plurality of emotion prediction scores.

Example 21. The computer-implemented method of example 1, wherein the emotion classification model comprises a supervised machine learning model and the machine learning summarization model comprises an unsupervised machine learning model and the computer-implemented method further comprises receiving training data for the emotion classification model, wherein the training data comprises one or more labelled text sequences; and training, via one or more supervised training techniques, the emotion classification model using the training data, wherein the one or more supervised training techniques comprise back propagation of errors and the emotion classification model is trained to optimize a classification loss.

Example 22: The computer-implemented method of example 21, wherein the training is performed by the one or more processors.

Example 23: The computer-implemented method of example 21, wherein the one or more processors are included in a first computing entity; and the training is performed by one or more other processors included in a second computing entity.

Example 24. The computing system of example 14, wherein the emotion classification model comprises a supervised machine learning model and the machine learning summarization model comprises an unsupervised machine learning model and the one or more processors are further configured to receive training data for the emotion classification model, wherein the training data comprises one or more labelled text sequences; and train, via one or more supervised training techniques, the emotion classification model using the training data, wherein the one or more supervised training techniques comprise back propagation of errors and the emotion classification model is trained to optimize a classification loss.

Example 25: The computing system of example 24, wherein the training is performed by the one or more processors.

Example 26: The computing system of example 24, wherein the one or more processors are included in a first computing entity; and the training is performed by one or more other processors included in a second computing entity.

Example 27. The one or more non-transitory computer-readable storage media of example 18, wherein the emotion classification model comprises a supervised machine learning model and the one or more processors are further configured to receive training data for the emotion classification model, wherein the training data comprises one or more labelled text sequences; and train, via one or more supervised training techniques, the emotion classification model using the training data, wherein the one or more supervised training techniques comprise back propagation of errors and the emotion classification model is trained to optimize a classification loss.

Example 28: The one or more non-transitory computer-readable storage media of example 27, wherein the training is performed by the one or more processors.

Example 29: The one or more non-transitory computer-readable storage media of example 27, wherein the one or more processors are included in a first computing entity; and the training is performed by one or more other processors included in a second computing entity.

1. A computer-implemented method comprising:
receiving, by one or more processors and from an emotion classification model, an emotion prediction vector for an utterance text segment from a transcript data object, the emotion prediction vector comprising a plurality of emotion prediction scores respectively corresponding to a plurality of emotion identifiers;
generating, by the one or more processors, a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category;
identifying, by the one or more processors, the utterance text segment as a relevant utterance from the transcript data object based on a comparison between the domain-specific relevancy prediction and a relevancy threshold; and
initiating, by the one or more processors, a performance of a machine learning summarization operation based on the utterance text segment.

2. The computer-implemented method of claim 1, wherein initiating the machine learning summarization operation comprises providing the relevant utterance as an input to a machine learning summarization model to receive a transcript summary for the transcript data object.

3. The computer-implemented method of claim 2, further comprising:
generating a transcript sentiment for the transcript data object based on a concluding subset of the plurality of emotion prediction scores that correspond to one or more concluding utterances from the transcript data object; and
assigning the transcript sentiment to the transcript summary.

4. The computer-implemented method of claim 3, wherein generating the transcript sentiment comprises:
generating a plurality of sentiment bucket scores based on the concluding subset of the plurality of emotion prediction scores, wherein:
(i) a sentiment bucket score comprises an aggregation of a bucket subset of the concluding subset of the plurality of emotion prediction scores that correspond to one or more bucket-specific emotion identifiers of the plurality of emotion identifiers; and
(ii) each of the plurality of sentiment bucket scores corresponds to a predefined sentiment option of a plurality of predefined sentiment options; and
identifying the transcript sentiment from the plurality of predefined sentiment options based on a comparison between the plurality of sentiment bucket scores.

5. The computer-implemented method of claim 1, further comprising:
receiving the transcript data object;
identifying the utterance text segment from the transcript data object; and
providing the utterance text segment as an input to the emotion classification model to receive the emotion prediction vector.

6. The computer-implemented method of claim 1, wherein:
(i) the one or more category-specific emotion identifiers are identified from a plurality of training transcripts based on a predictive correlation to the domain-specific summarization category; and
(ii) the predictive correlation is based on a similarity score between (a) a historical utterance of a training transcript that corresponds to the domain-specific summarization category and (b) a training summary of the training transcript.

7. The computer-implemented method of claim 6, wherein the training summary is generated using a large language model.

8. The computer-implemented method of claim 6, wherein the historical utterance is associated with a historical emotion prediction vector.

9. The computer-implemented method of claim 1, wherein the domain-specific relevancy prediction includes a probability that the utterance text segment is associated with (i) an expression of intent, (ii) an expression of a resolution, or (iii) an expression of contextual information.

10. The computer-implemented method of claim 1, further comprising removing one or more utterance text segments from the transcript data object based on one or more of: (i) a location of the one or more utterance text segments within the transcript data object or (ii) a content-based categorization of the one or more utterance text segments.

11. The computer-implemented method of claim 1, wherein the domain-specific relevancy prediction comprises an aggregation of the category-relevant subset of the plurality of emotion prediction scores.

12. A computing system comprising memory and one or more processors communicatively coupled to the memory, the one or more processors configured to:
receive, from an emotion classification model, an emotion prediction vector for an utterance text segment from a transcript data object, the emotion prediction vector comprising a plurality of emotion prediction scores respectively corresponding to a plurality of emotion identifiers;
generate a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category;
identify the utterance text segment as a relevant utterance from the transcript data object based on a comparison between the domain-specific relevancy prediction and a relevancy threshold; and
initiate a performance of a machine learning summarization operation based on the utterance text segment.

13. The computing system of claim 12, wherein initiating the machine learning summarization operation comprises providing the relevant utterance as an input to a machine learning summarization model to receive a transcript summary for the transcript data object.

14. The computing system of claim 13, wherein the one or more processors are further configured to:
generate a transcript sentiment for the transcript data object based on a concluding subset of the plurality of emotion prediction scores that correspond to one or more concluding utterances from the transcript data object; and
assign the transcript sentiment to the transcript summary.

15. The computing system of claim 14, wherein generating the transcript sentiment comprises:
generating a plurality of sentiment bucket scores based on the concluding subset of the plurality of emotion prediction scores, wherein:
(i) a sentiment bucket score comprises an aggregation of a bucket subset of the concluding subset of the plurality of emotion prediction scores that correspond to one or more bucket-specific emotion identifiers of the plurality of emotion identifiers; and
(ii) each of the plurality of sentiment bucket scores corresponds to a predefined sentiment option of a plurality of predefined sentiment options; and
identifying the transcript sentiment from the plurality of predefined sentiment options based on a comparison between the plurality of sentiment bucket scores.

16. The computing system of claim 12, wherein the one or more processors are further configured to:
receive the transcript data object;
identify the utterance text segment from the transcript data object; and
provide the utterance text segment as an input to the emotion classification model to receive the emotion prediction vector.

17. The computing system of claim 12, wherein:
(i) the one or more category-specific emotion identifiers are identified from a plurality of training transcripts based on a predictive correlation to the domain-specific summarization category; and
(ii) the predictive correlation is based on a similarity score between (a) a historical utterance of a training transcript that corresponds to the domain-specific summarization category and (b) a training summary of the training transcript.

18. One or more non-transitory computer-readable storage media including instructions that, when executed by one or more processors, cause the one or more processors to:
receive, from an emotion classification model, an emotion prediction vector for an utterance text segment from a transcript data object, the emotion prediction vector comprising a plurality of emotion prediction scores respectively corresponding to a plurality of emotion identifiers;
generate a domain-specific relevancy prediction for the utterance text segment based on a category-relevant subset of the plurality of emotion prediction scores that correspond to one or more category-specific emotion identifiers of the plurality of emotion identifiers associated with a domain-specific summarization category;
identify the utterance text segment as a relevant utterance from the transcript data object based on a comparison between the domain-specific relevancy prediction and a relevancy threshold; and
initiate a performance of a machine learning summarization operation based on the utterance text segment.

19. The one or more non-transitory computer-readable storage media of claim 18, wherein the instructions further cause the one or more processors to remove one or more utterance text segments from the transcript data object based on one or more of: (i) a location of the one or more utterance text segments within the transcript data object or (ii) a content-based categorization of the one or more utterance text segments.

20. The one or more non-transitory computer-readable storage media of claim 18, wherein the domain-specific relevancy prediction comprises an aggregation of the category-relevant subset of the plurality of emotion prediction scores.
